(19) United States
(12) Patent Application Publication
(10) Pub. No.: US 2024/0231103 A1
(43) Pub. Date: Jul. 11, 2024

(54) K-SPACE ANALYSIS FOR GEOMETRICAL WAVEGUIDE

(71) Applicant: Meta Platforms Technologies, LLC, Menlo Park, CA (US)

(72) Inventors: Miaomiao XU, Redmond, WA (US); Xingzhou TU, Redmond, WA (US)

(21) Appl. No.: 18/440,252

(22) Filed: Feb. 13, 2024

Related U.S. Application Data
(60) Provisional application No. 63/448,627, filed on Feb. 27, 2023.

(51) Int. Cl. G02B 27/01; G02B 27/00

(52) U.S. Cl. CPC G02B 27/0172; G02B 27/0018; G02B 27/0081; G02B 2027/014; G02B 2027/0178

(57) ABSTRACT

Techniques disclosed herein relate to waveguide-based near-eye display systems and techniques for analyzing the waveguide-based near-eye display systems using three-dimensional (3-D) k-vectors (wave vectors) in 3-D k-sphere. In one example, a geometrical waveguide display may include a substrate and a first plurality of transflective mirrors in the substrate, the first plurality of transflective mirrors characterized by a tilt angle of n×180°/N with respect to a surface of the substrate, where N is an odd number and n is an integer smaller than N.

### CROSS-REFERENCE TO RELATED APPLICATIONS

This application claims the benefit of and priority to U.S. Provisional Application No. 63/448,627, filed Feb. 27, 2023, entitled “K-SPACE ANALYSIS FOR GEOMETRICAL WAVEGUIDE,” which is hereby incorporated by reference in its entirety for all purposes.

### BACKGROUND

An artificial reality system, such as a head-mounted display (HMD) or heads-up display (HUD) system, generally includes a near-eye display (e.g., in the form of a headset or a pair of glasses) configured to present content to a user via an electronic or optic display within, for example, about 12-20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)), and the surrounding environment by, for example, seeing through transparent display glasses or lenses (often referred to as optical see-through).

One example of an optical see-through AR system may use a waveguide-based optical display, where light of projected images may be coupled into a waveguide (e.g., a transparent substrate), propagate within the waveguide, and be coupled out of the waveguide at different locations. In some implementations, the light of the projected images may be coupled into or out of the waveguide using diffractive optical elements, such as surface-relief gratings or volume Bragg gratings, or reflective optical elements, such as transflective mirrors. Light from the surrounding environment may pass through a see-through region of the waveguide and reach the user's eyes as well.

### SUMMARY

This disclosure relates generally to near-eye display systems. More specifically, techniques disclosed herein relate to waveguide-based near-eye display systems and techniques for analyzing the waveguide-based near-eye display systems. Various inventive embodiments are described herein, including devices, components, systems, assemblies, modules, subsystems, design/analysis techniques, methods, and the like.

According to certain embodiments, a geometrical waveguide display may include a substrate and a first plurality of transflective mirrors in the substrate, the first plurality of transflective mirrors characterized by a tilt angle of n×180°/N with respect to a surface of the substrate, where N is an odd number and n is an integer smaller than N. In some embodiments, the geometrical waveguide display may include a second plurality of transflective mirrors in the substrate, the second plurality of transflective mirrors characterized by a tilt angle of m×180°/N with respect to the surface of the substrate, where m is an integer smaller than N and is different from n. In some embodiments, the geometrical waveguide display may include a second plurality of transflective mirrors in the substrate, the second plurality of transflective mirrors characterized by a tilt angle of −n×180°/N with respect to the surface of the substrate. In some embodiments, a refractive index of the substrate may be greater than about 1.7.

In some embodiments, the substrate may extend in a first direction, and a first input coupler may be configured to couple display light into the substrate such that the display light may be reflected through total internal reflection by three or more surfaces of the substrate that are parallel to the first direction to propagate within the substrate in the first direction. The first plurality of transflective mirrors may be configured to reflect portions of the display light out of the substrate through a surface of the substrate. The substrate has a bar shape and has a cross-section characterized by a shape of a polygon. In some embodiments, the geometrical waveguide display may include a second plurality of transflective mirrors in the substrate, where the first plurality of transflective mirrors and the second plurality of transflective mirrors may be in different regions of the substrate, and the first plurality of transflective mirrors may be configured to reflect light towards the second plurality of transflective mirrors.

According to certain embodiments, a waveguide display may include a first pupil expander extending in a first direction, and a second pupil expander. The first pupil expander may be configured to: reflect display light through total internal reflection at three or more surfaces that are parallel to the first direction to guide the display light along the first direction; and couple the display light out of the first pupil expander at a first plurality of locations along the first direction. The second pupil expander may be configured to split the display light from each location of the first plurality of locations of the first pupil expander at a second plurality of locations along a second direction that is different from the first direction. The display light from each location of the first plurality of locations of the first pupil expander may be coupled into the second pupil expander through an edge of the second pupil expander.

In some embodiments of the waveguide display, the first pupil expander may include a first plurality of transflective mirrors. The first plurality of transflective mirrors may be characterized by a tilt angle of n×180°/N with respect to a surface of the first pupil expander, where N may be an odd number and n is an integer smaller than N. In some embodiments, the waveguide display may include a second plurality of transflective mirrors in the first pupil expander, the second plurality of transflective mirrors characterized by a tilt angle of m×180°/N with respect to the surface of the first pupil expander, where m is an integer smaller than N and is different from n. In some embodiments, the waveguide display may include a second plurality of transflective mirrors in the first pupil expander, the second plurality of transflective mirrors characterized by a tilt angle of −n×180°/N with respect to the surface of the waveguide display.

According to certain embodiments, a method of analyzing a waveguide display may include determining a wave vector frustum of an input light frustum in a three-dimensional (3-D) wave vector space (k-space), the wave vector frustum including a plurality of wave vectors \vec{k}ᵢₙ, determining a surface-normal vector î of a first reflector of the waveguide display, and determining a wave vector frustum of a light frustum reflected by the first reflector. The wave vector frustum of the light frustum reflected by the first reflector may include a plurality of wave vectors \vec{k}ᵣ determined according to:

$${\vec{k}}_{r} = {\vec{k}}_{i n} - 2 ( {\vec{k}}_{i n} \cdot \hat{n} ) \hat{n} .$$

The first reflector may include a surface of a waveguide of the waveguide display or a transflective mirror in the waveguide display.

In some embodiments, the method may include displaying the wave vector frustum of the input light frustum and the wave vector frustum of the light frustum reflected by the first reflector in a k-sphere. In some embodiments, the method may include determining a field of view supported by the waveguide display based on the wave vector frustum of the light frustum reflected by the first reflector in the k-sphere and regions of the k-sphere representing wave vectors of light that can be guided by the waveguide display. In some embodiments, the method may include determining a ghost image path of the waveguide display based on the wave vector frustum of the light frustum reflected by the first reflector in the k-sphere and regions of the k-sphere representing wave vectors of light that can escape from the waveguide display. In some embodiments, the input light frustum may include ambient light, and the method may include determining a rainbow image path of the waveguide display based on the wave vector frustum of the light frustum reflected by the first reflector in the k-sphere and regions of the k-sphere representing wave vectors of light that can escape from the waveguide display. In some embodiments, the method may include determining a surface-normal vector of a second reflector of the waveguide display, and determining a wave vector frustum of a light frustum reflected by the second reflector based on the wave vector frustum of the light frustum reflected by the first reflector and the surface-normal vector of the second reflector. In some embodiments, the method may include determining a grating vector of a volume Bragg grating of the waveguide display, and determining a wave vector frustum of a light frustum diffracted by the volume Bragg grating based on a wave vector frustum of an incident light frustum and the grating vector of the volume Bragg grating.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display according to certain embodiments.

FIG. 5 illustrates an example of an optical see-through augmented reality system including a waveguide display for exit pupil expansion according to certain embodiments.

FIG. 6A illustrates an example of a waveguide display system including a waveguide and diffraction gratings for exit pupil expansion.

FIG. 6B illustrates an example of an eyebox including two-dimensional replicated exit pupils.

FIG. 7 illustrates an example of a waveguide display including two waveguides for two-dimensional (2-D) pupil expansion.

FIG. 8A includes a curve illustrating the angular bandwidth of an example of a volume Bragg grating (VBG).

FIG. 8B includes a curve illustrating the angular bandwidth of an example of a transflective mirror.

FIG. 9A illustrates an example of a waveguide display including three or four groups of reflective and/or transflective mirrors for two-dimensional pupil expansion and dispersion compensation according to certain embodiments.

FIG. 9B shows an example of an input coupler that includes a mirror according to certain embodiments.

FIG. 9C shows another example of an input coupler that includes a mirror and a plurality of transflective mirrors according to certain embodiments.

FIGS. 10A-10D illustrate an example of a kaleidoscopic waveguide for pupil expansion and 2-D FOV expansion in a waveguide display according to certain embodiments.

FIG. 11A illustrates an example of a geometrical waveguide display.

FIG. 11B illustrates examples of transflective mirrors in a geometrical waveguide display.

FIG. 12A illustrates an example of a light beam propagating in an example of a waveguide.

FIG. 12B illustrates an example of a wave vector (k-vector) representing a light beam propagating in a waveguide and incident on a transflective mirror.

FIG. 13A illustrates an example of a light beam reflected by a specular reflector.

FIG. 13B illustrates the wave vectors of the incident light beam and the reflected light beam shown in FIG. 13A.

FIG. 13C illustrates the wave vectors (k-vectors) of the incident light beam and the reflected light beam of FIG. 13A in k-space.

FIG. 14A illustrates an example of light beams from different fields of view (e.g., in a light frustum) reflected by a specular reflector.

FIG. 14B illustrates the wave vectors of the incident light beams and the reflected light beams shown in FIG. 14A.

FIG. 14C illustrates the wave vectors of the incident light beams and the reflected light beams of FIG. 14A in k-space.

FIG. 15A illustrates an example of a light beam in a frustum incident on a geometrical waveguide display.

FIG. 15B illustrates orientations of examples of transflective mirrors in an example of a geometrical waveguide display.

FIG. 15C illustrates k-vectors of the incident light and k-vectors of light reflected by a transflective mirror of the geometrical waveguide display of FIG. 15B in a k-sphere.

FIG. 15D illustrates k-vectors of the incident light and k-vectors of light reflected by a transflective mirror of the geometrical waveguide display of FIG. 15B in a k-sphere projected onto a plane (e.g., an x-y plane).

FIG. 16A illustrates the orientation of a transflective mirror in an example of a geometrical waveguide display.

FIG. 16B illustrates k-vectors in a k-sphere indicating light that may be guided by the geometrical waveguide display.

FIGS. 17A-17B illustrate the critical cones in a k-sphere indicating light that may be guided by a geometrical waveguide display having a surface-normal direction in a vertical direction.

FIGS. 17C-17D illustrate the critical cone in a k-sphere indicating light that may be guided by a tilted geometrical waveguide display (with a surface-normal direction tilted with respect to a vertical direction).

FIG. 18A illustrates an example of a geometrical waveguide display including multiple groups of mirrors for pupil expansion.

FIG. 18B illustrates k-vectors of an input light beam of a geometrical waveguide display projected onto a plane (e.g., an x-y plane) of a k-sphere.

FIG. 18C illustrates k-vectors of an input light beam and the corresponding output light beam of a geometrical waveguide display projected onto a plane (e.g., an x-y plane) of a k-sphere.

FIG. 18D illustrates the k-vectors of an input light beam, a light beam reflected by an input mirror, a light beam reflected by a folding mirror, and the corresponding output light beam of the geometrical waveguide display of FIG. 18A being projected onto a plane (e.g., an x-z plane) of a 3-D k-sphere.

FIG. 19A illustrates light reflections by four surfaces of an example of a kaleidoscopic waveguide according to certain embodiments.

FIG. 19B illustrates an example of analyzing the kaleidoscopic waveguide of FIG. 19A using k-vectors in a 3-D k-sphere according to certain embodiments.

FIGS. 20A-20B illustrate an example of a geometrical waveguide display including a kaleidoscopic waveguide for pupil expansion and 2-D FOV expansion according to certain embodiments.

FIG. 21A illustrates an example of a geometrical waveguide display including a kaleidoscopic waveguide according to certain embodiments.

FIG. 21B illustrates k-vectors of light reflected by the geometrical mirrors of the kaleidoscopic waveguide of FIG. 21A, where the k-vectors may be projected onto a plane (e.g., a y-z plane) of a k-sphere.

FIG. 21C illustrates k-vectors of light reflected by the geometrical mirrors of the kaleidoscopic waveguide of FIG. 21A, where the k-vectors may be projected onto a plane (e.g., an x-z plane) of a k-sphere.

FIG. 22 illustrates k-vectors of light that may be guided by waveguides of a geometrical waveguide display including a kaleidoscopic waveguide.

FIGS. 23A-23C illustrate examples of light reflection by mirrors of a geometrical waveguide display.

FIG. 24 illustrates k-vectors of an example of a light frustum propagating within a geometrical waveguide.

FIG. 25 illustrates k-vectors of an example of a light frustum propagating within a geometrical waveguide and an example of a light frustum reflected by a mirror of the geometrical waveguide.

FIG. 26 illustrates k-vectors of light frustums propagating within a geometrical waveguide and reflected by mirrors and surfaces of the geometrical waveguide.

FIG. 27A illustrates k-vectors of light beams in a light frustum propagating within an example of a geometrical waveguide and reflected by surfaces and transflective mirrors having a first orientation (e.g., about 60° with respect to a surface of the geometrical waveguide) in the geometrical waveguide.

FIG. 27B illustrates k-vectors of light beams propagating within an example of a geometrical waveguide and reflected by surfaces and transflective mirrors having a second orientation (e.g., about 36° with respect to a surface of the geometrical waveguide) in the geometrical waveguide.

FIG. 27C illustrates k-vectors of light beams propagating within an example of a geometrical waveguide and reflected by surfaces and transflective mirrors having a third orientation (e.g., about 180/7=25.7° with respect to a surface of the geometrical waveguide) in the geometrical waveguide.

FIG. 28A illustrates k-vectors of light beams propagating within an example of a geometrical waveguide and reflected by surfaces and transflective mirrors having a first orientation (e.g., about 45° with respect to a surface of the geometrical waveguide) in the geometrical waveguide.

FIG. 28B illustrates k-vectors of light beams propagating within an example of a geometrical waveguide and reflected by surfaces and transflective mirrors having a second orientation (e.g., about 30° with respect to a surface of the geometrical waveguide) in the geometrical waveguide.

FIG. 28C illustrates k-vectors of light beams propagating within an example of a geometrical waveguide and reflected by surfaces and transflective mirrors having a third orientation (e.g., about 22.5° with respect to a surface of the geometrical waveguide) in the geometrical waveguide.

FIGS. 29A-29D illustrate various examples of light paths of rainbow images in an example of a geometrical waveguide.

FIG. 30 illustrates examples of k-vectors of rainbow images in an example of a geometrical waveguide.

FIG. 31A illustrates examples of k-vectors of rainbow light in an example of a geometrical waveguide including transflective mirrors having a first orientation (e.g., about 180°/3=60° with respect to the front or back surface of the geometrical waveguide) in the geometrical waveguide.

FIG. 31B illustrates examples of k-vectors of rainbow light in an example of a geometrical waveguide including transflective mirrors having a second orientation (e.g., about 180°/5=36° with respect to the front or back surface of the geometrical waveguide) in the geometrical waveguide.

FIG. 32A illustrates examples of k-vectors of rainbow light in an example of a geometrical waveguide including transflective mirrors having a first orientation (e.g., about 180°/4=45° with respect to a front or back surface of the geometrical waveguide) in the geometrical waveguide.

FIG. 32B illustrates examples of k-vectors of rainbow light in an example of a geometrical waveguide including transflective mirrors having a second orientation (e.g., about 180°/6=30° with respect to a front or back surface of the geometrical waveguide) in the geometrical waveguide.

FIG. 33A illustrates an example of a geometrical waveguide display including four groups of mirrors according to certain embodiments.

FIG. 33B illustrates an example of a geometrical waveguide display including three groups of mirrors according to certain embodiments.

FIG. 34A illustrates k-vectors of incident light and k-vectors of light reflected by a transflective mirror of a geometrical waveguide display in a k-sphere.

FIG. 34B illustrates k-vectors of incident light and k-vectors of light reflected by the transflective mirror of the geometrical waveguide display as projected onto a plane (e.g., an x-y plane) of the k-sphere.

FIG. 35 illustrates examples of k-vectors of light in an example of a geometrical waveguide including mirrors having a certain orientation in the geometrical waveguide.

FIG. 36 illustrates examples of k-vectors of light in an example of a geometrical waveguide including mirrors having a certain orientation in the geometrical waveguide.

FIG. 37A illustrates an example of a geometrical waveguide including mirrors having different orientations inside the geometrical waveguide.

FIG. 37B illustrates examples of k-vectors of light in an example of a geometrical waveguide including mirrors having different orientations.

FIG. 38A illustrates an example of a volume Bragg grating (VBG) formed on a substrate.

FIG. 38B illustrates the relationship between the wave vector of a light beam diffracted by a VBG, and the grating vector of the VBG and the wave vector of the input beam.

FIG. 39 is a simplified block diagram of an electronic system of an example of a near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to near-eye display systems. More specifically, techniques disclosed herein relate to waveguide-based near-eye display systems and techniques for analyzing the waveguide-based near-eye display systems. Various inventive embodiments are described herein, including devices, components, systems, assemblies, modules, subsystems, design/analysis techniques, methods, and the like.

An optical see-through near-eye display system for augmented reality or mixed reality applications generally includes an image source (e.g., a micro-display), an optical combiner, and an eyepiece. The optical combiner may include, for example, a flat beam splitter, a curved or freeform surface with a beam-splitting coating, a diffractive (e.g., holographic) waveguide, or a geometrical waveguide. Optical combiners made of flat beam splitters or freeform surfaces may have high image quality but may have large sizes. Waveguide displays using, for example, diffractive couplers (e.g., volume Bragg gratings or surface-relief gratings) or transflective mirrors, can be made thin and compact. In waveguide displays, multiple waveguides and/or couplers may be used to replicate the exit pupil, thereby increasing the size of the eyebox so that the user's eyes may be able to view the displayed image even if the user's eyes move within a large area. To achieve a large field of view (FOV), a waveguide display using diffractive couplers or transflective mirrors may generally need to have a large form factor.

Optical see-through near-eye display systems that employ waveguides and diffraction gratings (e.g., volume Bragg gratings (VBGs)) to present display images from a projector to user's eyes may have limited field of view (FOV) and spectrum coverage, due to, for example, limited angular and spectral bandwidth of the diffraction gratings. Some diffraction gratings such as VBGs may have also limited diffraction efficiencies. In addition, multiple gratings used for one-dimensional or two-dimensional pupil expansion may perform multiple times of optical filtering (e.g., Bragg filtering due to limited bandwidths of the VBGs) on the display images, which may lead to optical artifacts such as intercepting optical line patterns that may reduce the quality of the display images.

In some implementations, an optical see-through near-eye display system may include a waveguide with one or more arrays of partially reflective mirrors embedded in multiple locations of the waveguide to direct display images from the multiple locations to user's eyes, thereby replicating the exit pupil and expanding the eyebox in one or two dimensions. The partially reflective mirrors may also be referred to as transflective mirrors, geometric mirrors, or geometric reflectors. A waveguide including transflective mirrors in the waveguide may be referred to as a geometrical waveguide. A transflective mirror may split incident light by partially reflecting the incident light and partially transmitting the incident light such that a portion of the incident light may continue to propagate within the waveguide to be split by other transflective mirrors. Such near-eye display systems may be referred to as geometrical waveguide display systems. In some embodiments, a geometrical waveguide display may include 3 or 4 groups of geometrical reflectors to achieve full and complete color dispersion compensation, where the display light may interact with both input mirrors and output mirrors that have the same mirror orientations, and may interact with both a first group of middle mirrors and a second group of middle mirrors (or different regions of a same group of middle mirrors) that may have the same mirror orientations. The combination of multiple groups of mirrors can produce close to zero dispersion from waveguide input to waveguide output and the eyebox, for visible light (e.g., red, green, and blue light) from all angles.

In some implementations, to reduce the size of a waveguide display, a long bar-shaped waveguide may be used to split the input display light into a one-dimensional (1-D) array of light beams along one direction (e.g., the length direction of the bar-shaped waveguide), thereby replicating the pupil in one dimension. A larger waveguide may receive the 1-D array of light beams and split each light beam into an array of light beams along another direction, thereby replicating the pupil in another dimension. Therefore, two-dimensional (2-D) pupil replication may be achieved by the combination of the bar-shaped waveguide and the larger waveguide to expand the eyebox. The bar-shaped waveguide may have a relatively small FOV in at least one dimension (e.g., a line FOV with about 0° FOV in a direction perpendicular to the length direction of the bar-shaped waveguide) to avoid reflections by sidewalls that may result in optical artifacts such as ghost images. A scanning mirror (e.g., a galvanometer mirror or microelectromechanical system (MEMS) mirrors) may be used to scan the array of light beams from the bar-shaped waveguide to increase the FOV in the dimension perpendicular to the length direction of the bar-shaped waveguide, to achieve a larger 2-D field of view. Using the scanning mirror may increase the size, complexity, and cost, and reduce the reliability of the waveguide display.

According to some embodiments, a kaleidoscopic waveguide may be used to replicate the pupil of a waveguide display in one dimension and also increase the FOV of the waveguide display, and thus a scanning mirror may not be used in the waveguide display. The kaleidoscopic waveguide may have a similar shape and size as the bar-shaped waveguides in waveguide displays that use scanning mirrors, but may be configured to guide the display light coupled into the kaleidoscopic waveguide in different manners. For example, display light coupled into a kaleidoscopic waveguide may be reflected by more than two surfaces of the kaleidoscopic waveguide, such as four surfaces of a kaleidoscopic waveguide having a rectangular cross-section, thereby creating multiple images of different parity in each round trip (e.g., including four reflections at the four surfaces due to total internal reflection). The kaleidoscopic waveguide can be configured such that the reflections by sidewalls may not cause optical artifacts or may only cause tolerable optical artifacts, and thus the FOV of the kaleidoscopic waveguide can be large in two dimensions. One or more of the multiple images covering a large 2-D FOV may be coupled out of the kaleidoscopic waveguide by, for example, a grating or transflective mirrors, through one surface of the kaleidoscopic waveguide, towards a second waveguide. The second waveguide may replicate the exit pupil in another dimension to achieve 2-D pupil expansion. In this way, a waveguide display including a kaleidoscopic waveguide may have a small form factor and no moving parts (e.g., a scanning mirror), and may be able to achieve 2-D pupil expansion and a large 2-D FOV.

It can be challenging to design and analyze these waveguide displays that include, for example, kaleidoscopic waveguides, multiple groups of gratings or transflective mirrors for pupil expansion, or a combination, to achieve the desired performance, such as a large field of view, a low rainbow effect or ghost image, high image quality, and high energy efficiency. For example, ray-tracing techniques may be time-consuming and/or may require large computation power. 2-D k-vector analysis using k-circles may not be able to analyze the light propagation in 3-D space in waveguide displays. Thus, a systematic technique may be needed to analyze the light propagation in order to design the waveguide display. For example, it may be desirable to track the angular information of the light in the image path, analyze the FOV supported by the waveguide (e.g., limited by the critical angle), analyze potential ghost path and mitigation plan, and analyze the FOV limitation in geometrical waveguides, which may be more complicated than, for example, analyzing surface-relief grating-based waveguide displays and may need 3-D analysis.

According to certain embodiments, a method of designing and/or analyzing waveguide displays (e.g., geometrical waveguide displays or VBG-based diffractive waveguide displays) may use k-vectors (wave vectors) in k-sphere to visualize light propagation within the waveguide displays in 3-D space. For example, the method may include determining a wave vector frustum of an input light frustum in a 3-D wave vector space (k-space), determining a surface-normal vector î of a reflector of the waveguide display or a grating vector of a VBG of the waveguide display, and determining a wave vector frustum of a light frustum reflected by the reflector according to \vec{k}ᵣ=\vec{k}ᵢₙ−2(\vec{k}ᵢₙ·\hat{n})\hat{n} (or determining a wave vector frustum of a light frustum diffracted by the VBG based on a vector triangle), where \vec{k}ᵢₙ is a wave vector of a light ray in the input light frustum, and \vec{k}ᵣ is a wave vector of a light ray in the light frustum reflected by the reflector. The wave vector frustum of the input light frustum, and the wave vector frustum of the light frustum reflected by the reflector or diffracted by the VBG may be visualized in a k-sphere. The FOV supported by the waveguide display, ghost image path of the waveguide display, the rainbow image path of the waveguide display, and the like, may then be analyzed based on the wave vector frustum in the 3-D k-space.

Techniques disclosed herein can be used to analyze the evolution of k-vectors as light propagating along the light path in a waveguide display, such as, for example, 1-D, 2-D, or kaleidoscopic geometrical waveguides that includes mirrors or volume gratings with multiple different orientations. Several examples of waveguide displays designed and/or analyzed using the comprehensive k-sphere analysis technique disclosed herein are also disclosed.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

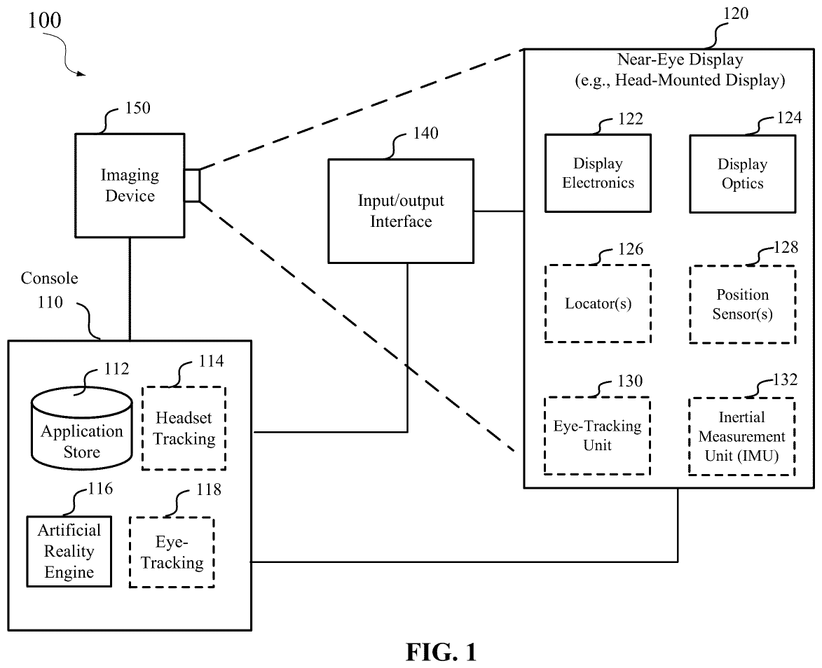

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

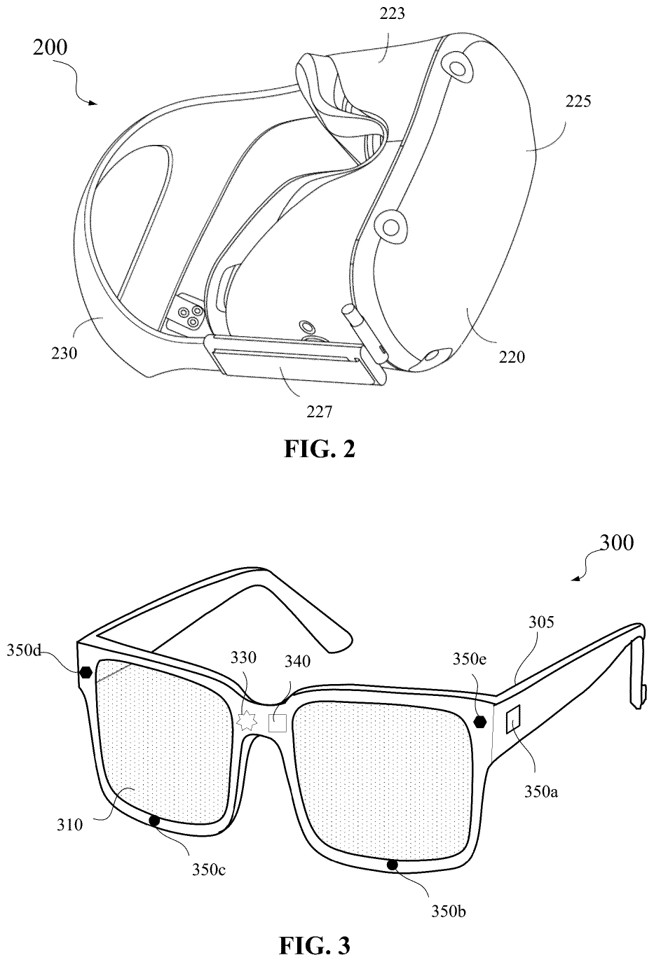

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (uLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3-D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light-emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 12 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 120 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking subsystem 114, an artificial reality engine 116, and an eye-tracking subsystem 118. Some embodiments of console 110 may include different or additional devices or subsystems than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the devices or subsystems of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking subsystem 114 may track movements of near-eye display 120 using slow calibration information from external imaging device 150. For example, headset tracking subsystem 114 may determine positions of a reference point of near-eye display 120 using observed locators from the slow calibration information and a model of near-eye display 120. Headset tracking subsystem 114 may also determine positions of a reference point of near-eye display 120 using position information from the fast calibration information. Additionally, in some embodiments, headset tracking subsystem 114 may use portions of the fast calibration information, the slow calibration information, or any combination thereof, to predict a future location of near-eye display 120. Headset tracking subsystem 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking subsystem 114. Artificial reality engine 116 may also receive estimated eye position and orientation information from eye-tracking subsystem 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking subsystem 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking subsystem 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2-D) or three-dimensional (3-D) images), videos (e.g., 2-D or 3-D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a uLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. High-resolution camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

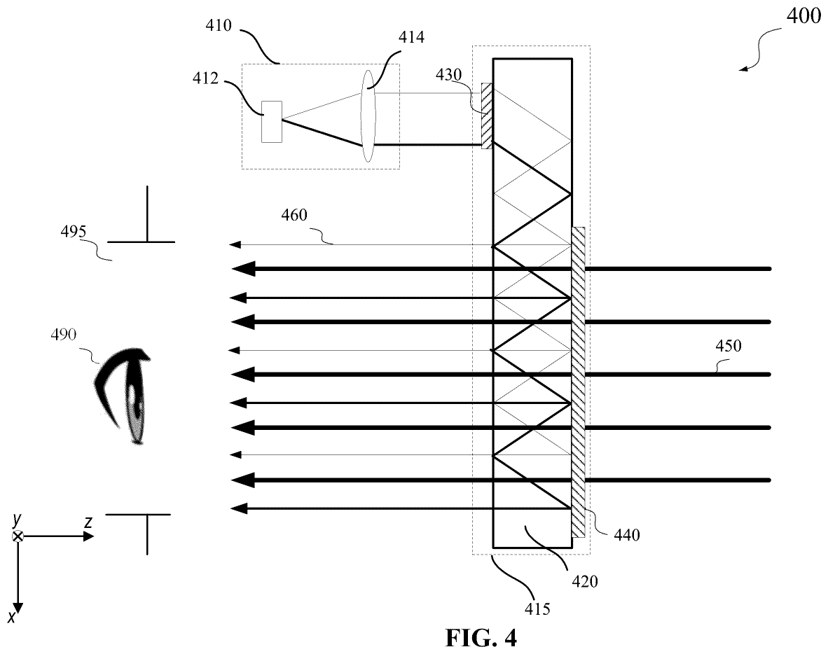

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Combiner 415 may transmit light in a first wavelength range, such as visible light from about 400 nm to about 650 nm. Input coupler 430 may include a volume holographic grating, a diffractive optical element (DOE) (e.g., a surface-relief grating), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 12 mm or more. Substrate 420 may be transparent to visible light.

Substrate 420 may include or may be coupled to a plurality of output couplers 440, each configured to extract at least a portion of the light guided by and propagating within substrate 420 from substrate 420, and direct extracted light 460 to an eyebox 495 where an eye 490 of the user of augmented reality system 400 may be located when augmented reality system 400 is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements, prisms, etc. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a very low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

In some embodiments, projector 410, input coupler 430, and output coupler 440 may be on any side of substrate 420. Input coupler 430 and output coupler 440 may be reflective gratings (also referred to as reflective gratings) or transmissive gratings (also referred to as transmissive gratings) to couple display light into or out of substrate 420.

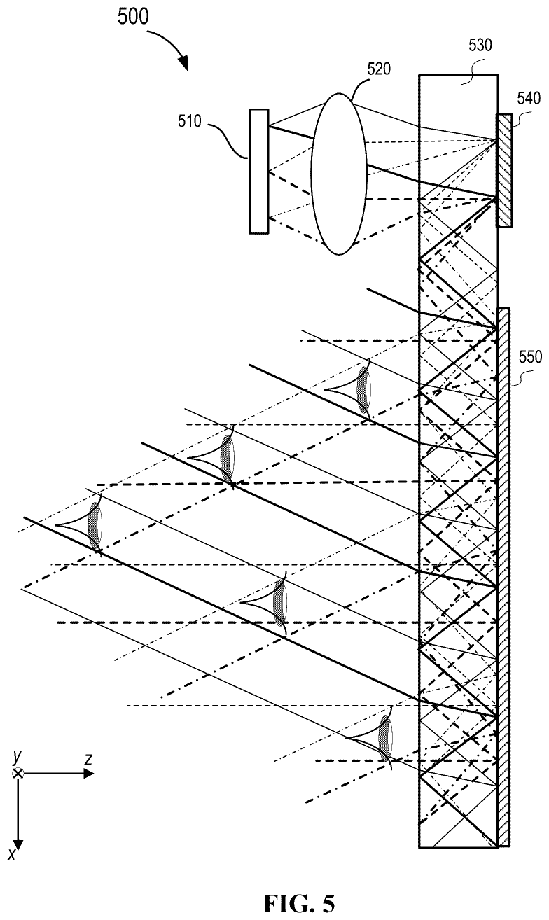

FIG. 5 illustrates an example of an optical see-through augmented reality system 500 including a waveguide display for exit pupil expansion according to certain embodiments. Augmented reality system 500 may be similar to augmented reality system 500, and may include the waveguide display and a projector that may include a light source or image source 510 and projector optics 520. The waveguide display may include a substrate 530, an input coupler 540, and a plurality of output couplers 550 as described above with respect to augmented reality system 500. While FIG. 5 only shows the propagation of light from a single field of view, FIG. 5 shows the propagation of light from multiple fields of view.

FIG. 5 shows that the exit pupil is replicated by output couplers 550 to form an aggregated exit pupil or eyebox, where different regions in a field of view (e.g., different pixels on image source 510) may be associated with different respective propagation directions towards the eyebox, and light from a same field of view (e.g., a same pixel on image source 510) may have a same propagation direction for the different individual exit pupils. Thus, a single image of image source 510 may be formed by the user's eye located anywhere in the eyebox, where light from different individual exit pupils and propagating in the same direction may be from a same pixel on image source 510 and may be focused onto a same location on the retina of the user's eye. In other words, the user's eye may convert angular information in the eyebox or exit pupil (e.g., corresponding to a Fourier plane) to spatial information in images form on the retina. FIG. 5 shows that the image of the image source is visible by the user's eye even if the user's eye moves to different locations in the eyebox.

As described above, in a waveguide-based near-eye display system, light of projected images may be coupled into a waveguide (e.g., a transparent substrate), propagate within the waveguide through total internal reflection, and be coupled out of the waveguide at multiple locations to replicate the exit pupil and expand the eyebox. Multiple waveguides and/or multiple couplers (e.g., gratings or transflective mirrors) may be used to replicate the exit pupil in two dimensions to fill a large eyebox (e.g., 40×40 mm² or larger) with a 2-D array of pupils (e.g., 2×2 mm²), thereby expanding the eyebox such that the user's eyes can view the displayed image even if the user's eyes move within a large area. For example, two or more gratings may be used to expand the display light in two dimensions or along two axes. The two gratings may have different grating parameters, such that one grating may be used to replicate the exit pupil in one direction and the other grating may be used to replicate the exit pupil in another direction. In such waveguide display systems, to achieve a large FOV, the two or more gratings may need to be large, and thus the waveguide display may have a large form factor (e.g., a large area). In some implementations, to reduce the size the waveguide displays, a long bar-shaped waveguide may be used to split the input display light into a one-dimensional (1-D) array of light beams along one direction (e.g., the length direction of the bar-shaped waveguide), thereby replicating the pupil in one dimension. A larger waveguide may receive the 1-D array of light beams and split each light beam into an array of light beams along another direction, thereby replicating the pupil in another dimension. Therefore, two-dimensional (2-D) pupil replication may be achieved by the combination of the bar-shaped waveguide and the larger waveguide to expand the eyebox. The long bar-shaped waveguide and the larger waveguide may be stacked to form a three-dimensional structure and reduce the form factor (e.g., the total area) of the waveguide display.

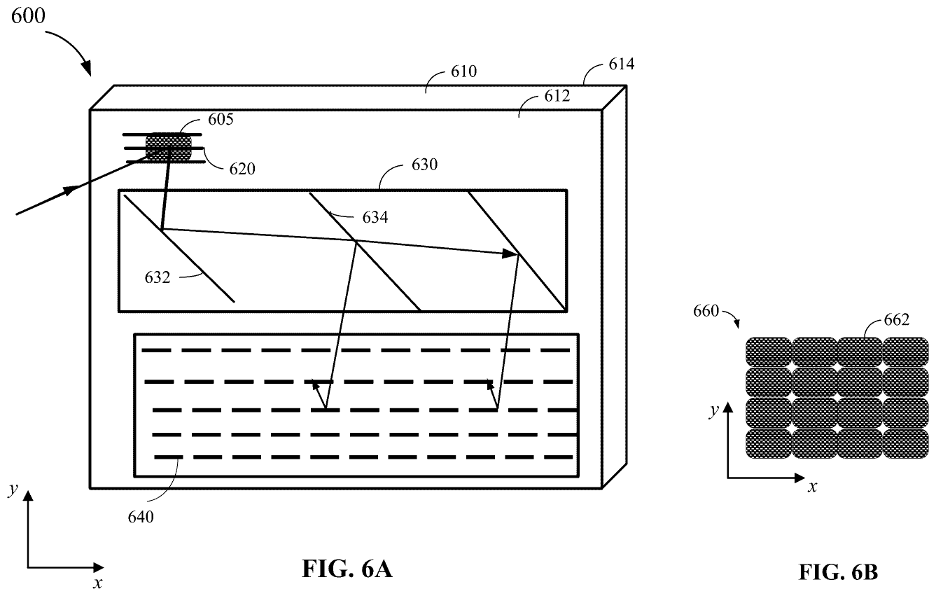

FIG. 6A illustrates an example of a waveguide display system 600 including a waveguide (e.g., including one or more substrates) and diffraction gratings for exit pupil expansion. Waveguide display system 600 may include a substrate 610, which may be similar to substrate 530 and may be used as a waveguide to guide light through total internal reflection. Substrate 610 may be transparent to visible light and may include, for example, a glass, quartz, plastic, polymer, PMMA, ceramic, Si₃N₄, or crystal substrate. Substrate 610 may be a flat substrate or a curved substrate, and may include a single layer of a material or may including a layer stack. Substrate 610 may include a first broadside surface 612 and a second broadside surface 614.

In the illustrated example, waveguide display system 600 may also include an input coupler 620, a middle grating 630, and an output grating 640. Input coupler 620, middle grating 630, and output grating 640 may be formed on or in Substrate 610. Input coupler 620 may include a grating, a refractive coupler (e.g., a wedge or a prism), or a reflective coupler (e.g., a slanted reflective surface). For example, in one embodiment, input coupler 620 may include a prism that may couple display light of different colors and for different fields of view into substrate 610 by refraction. In another example, input coupler 620 may include a grating coupler that may diffract light of different colors into substrate 610 at different angles. Input coupler 620 may have a coupling efficiency of greater than 12%, 20%, 30%, 50%, 75%, 90%, or higher for visible light. In some embodiments, waveguide display system 600 may include projector optics (e.g., a lens, not shown in FIG. 6A), where display light from an image source may be collimated by the projector optics and projected onto input coupler 620, which may then couple the display light into substrate 610 by diffraction, refraction, or reflection. The light coupled into substrate 610 may be reflected by first broadside surface 612 and second broadside surface 614 through total internal reflection, such that the display light may propagate within substrate 610.

Middle grating 630 and output grating 640 may be positioned on one or two surfaces (e.g., first broadside surface 612 and second broadside surface 614) of substrate 610 for expanding incident display light beam in two dimensions to fill the eyebox with the display light. Middle grating 630 may be configured to expand the display light along one direction, such as approximately in the x direction. Output grating 640 may then expand the display light from middle grating 630 in a different direction (e.g., approximately in the y direction).

For example, as illustrated in FIG. 6A, display light coupled into substrate 610 and propagating within substrate 610 may reach a first portion 632 of middle grating 630 and may be diffracted by first portion 632 of middle grating 630 to change the propagation direction to a first direction (e.g., approximately the x direction) towards a second portion 634 of middle grating 630. As shown in FIG. 6A, while the display light propagates within substrate 610 along the first direction, a portion of the display light may be diffracted by a region of second portion 634 of middle grating 630 towards output grating 640, each time the display light propagating within substrate 610 reaches second portion 634 of middle grating 630. Output grating 640 may then expand the display light from middle grating 630 in a different direction (e.g., approximately in the y direction) by diffracting a portion of the display light to the eyebox each time the display light propagating within substrate 610 reaches output grating 640. As such, middle grating 630 and output grating 640 may replicate incident display light beam in two dimensions to fill an eyebox with the display light.

FIG. 6B illustrates an example of an eyebox including two-dimensional replicated exit pupils. FIG. 6B shows that a single input pupil 605 may be replicated by middle grating 630 and output grating 640 to form an aggregated exit pupil 660 that includes a two-dimensional array of individual exit pupils 662. For example, the exit pupil may be replicated in approximately the x direction by middle grating 630 and in approximately the y direction by output grating 640. As described above, output light from individual exit pupils 662 and propagating in a same direction may be focused onto a same spot in the retina of the user's eye. Thus, a single image may be formed by the user's eye using the output light in the two-dimensional array of individual exit pupils 662.

In some embodiments, first portion 632 and second portion 634 of middle grating 630 may be on a same holographic material layer and may have matching grating vectors (e.g., having a same grating vector in the x-y plane and a same grating vector and/or opposite grating vectors in the z direction). Due to the opposite Bragg conditions (e.g., +1 order and −1 order diffractions) for the diffractions at first portion 632 and second portion 634 of middle grating 630, first portion 632 and second portion 634 may compensate for the light dispersion caused by each other to reduce the overall light dispersion. In addition, an input grating of input coupler 620 and output grating 640 may have matching grating vectors (e.g., having the same grating vector in the x-y plane and having the same or opposite grating vectors in the z direction), where the input grating may couple the display light into substrate 610, while output grating 640 may couple the display light out of substrate 610. Due to the opposite diffraction directions and opposite Bragg conditions (e.g., +1 order and −1 order diffractions) for the diffractions at input coupler 620 and output grating 640, input coupler 620 and output grating 640 may compensate for the light dispersion caused by each other to reduce the overall dispersion. In this way, the light dispersion by first portion 632 and second portion 634 of middle grating 630 may be canceled out, and the dispersion by the input grating of input coupler 620 and output grating 640 may also be canceled out. Therefore, the overall dispersion of the display light by waveguide display system 600 can be minimized. As such, a higher resolution of the displayed image may be achieved.

FIG. 7 illustrates an example of a waveguide display 700 including two waveguides for two-dimensional (2-D) pupil expansion. In the illustrated example, waveguide display 700 may include a first assembly 710 that may include a light source 712 for generating display light, a projector 714 for projecting the display light onto an input coupler 717 for a first waveguide 716. Input coupler 717 may couple the display light into first waveguide 716 such that the display light may be guided by first waveguide 716 through total internal reflection to propagate within first waveguide 716 in approximately the −x direction. An output coupler 718 for first waveguide 716 may couple a portion of the display light guided by first waveguide 716 out of first waveguide 716, each time the display light is incident on output coupler 718. Therefore, first waveguide 716 may split the display light into multiple display light beams 740 that are output at multiple locations along a first direction (e.g., the x direction). The multiple display light beams 740 generated by first assembly 710 may be coupled into a second waveguide 720 by an input coupler 750 such that display light beams 740 may be guided by second waveguide 720 to propagate along approximately the −y direction. Display light guided by second waveguide 720 may be coupled out of second waveguide 720 towards user's eye 790 (or an eyebox) each time the display light is incident on an output coupler 760. Therefore, second waveguide 720 may split each display light beam 740 into multiple display light beams that are output at multiple locations along a second direction (e.g., the y direction).

Light source 712 may include, for example, one or more laser diodes, light emitting diodes (LEDs), micro-LEDs, resonant-cavity LEDs (RC-LEDs), vertical cavity surface emitting lasers (VCSELs), organic LEDs (OLEDs), micro-OLEDs, liquid crystal display (LCD) cells, and the like. Light source 712 may emit visible light of multiple colors, such as red, green, and blue light. In some embodiments, light source 712 may include one or more rows or one or more columns of light emitters of different colors, such as multiple rows of red light emitters, multiple rows of green light emitters, and multiple rows of blue light emitters. In some embodiments, light source 712 may include a 2-D array of light emitters.

Projector 714 may include one or more optical components that can condition the display light from light source 712. Conditioning display light from light source 712 may include, for example, expanding, collimating, converging, diverging, or a combination thereof. In some embodiments, the optical power of projector 714 may be adjusted by, for example, mechanically translating a projection lens relative to light source 712, or using a tunable liquid crystal lens that can adjust the optical power under the control of a controller (not shown in FIG. 7). The one or more optical components may include, for example, lenses, mirrors, apertures, gratings, prisms, or a combination thereof.

Input coupler 717 may include, for example, a grating, a prism or wedge, or a reflecting surface, and may couple the display light from projector 714 into first waveguide 716 through diffraction, refraction, or reflection. First waveguide 716 may be characterized by a shape of long bar, and may have a relatively small form factor. In one example, first waveguide 716 may be approximately 50 mm or longer along the x dimension, about 5-10 mm (e.g., about 7 mm) along the y dimension, and about 0.3-1 mm along the z dimension. First waveguide 716 may be configured to expand the display light (e.g., via pupil replication) in one dimension (e.g., the x direction) through total internal reflection by surfaces of first waveguide 716 and output coupling by output coupler 718 as described above with respect to, for example, FIGS. 4 and 5. Output coupler 718 may include, for example, a surface-relief grating (SRG), a holographic grating (e.g., a volume Bragg grating (VBG)), a polarization volume hologram (PVH), partial reflectors (e.g., transflective mirrors that can partially reflect incident light and partially transmit incident light), a micro-mirror array, and the like.

Second waveguide 720 may have a larger form factor, such as having a width greater than about 40 mm, 50 mm, 70 mm, or larger. Second waveguide 720 may receive display light beams 740 at input coupler 750, which may couple the display light into second waveguide 720. Input coupler 750 may include, for example, a surface-relief grating, a holographic grating, a PVH, and the like. Second waveguide 720 may guide the received display light to output coupler 760. Output coupler 760 may include, for example, a holographic grating (e.g., VBGs) or an array of transflective mirrors, and may split and couple each display light beam 740 out of second waveguide 720 towards user's eye 790 (or an eyebox) at multiple locations along approximately the y direction, thereby replicating the exit pupil along the y direction.

As such, the exit pupil may be replicated along approximately the x direction by first waveguide 716 and may be further replicated along approximately the y direction by second waveguide 720 to achieve 2-D pupil expansion. In some embodiments, the replicated exit pupils may partially overlap in the eyebox. The pupil expansion may occur in two directions that may or may not be orthogonal. The replicated pupils may fill an eyebox (e.g., ≥10-40 mm or larger in diameter or width), such that the user's eye 790 may view the displayed content even if it moves within the eyebox.

A bar-shaped waveguide (e.g., first waveguide 716) may reduce the form factor of the waveguide display, but may have a relatively small FOV in at least one dimension (e.g., in the y direction in the example shown in FIG. 7). In some implementations, a scanning mirror (e.g., a galvanometer mirror or microelectromechanical system (MEMS) mirrors) may be used to scan the array of light beams from the bar-shaped waveguide in one direction (e.g., the y direction) to increase the FOV in the direction and achieve a large 2-D field of view.

Each of the input grating in input coupler 620, first portion 632 and second portion 634 of middle grating 630, output grating 640, input coupler 717, output coupler 718, input coupler 750, and output coupler 760 may include multiplexed VBGs configured to diffract display light of different colors and/or from different fields of view. Because each VBG of the multiplexed VBGs may have limited wavelength and/or angular bandwidth, different VBGs having different wavelength and/or angular bandwidths may be used to diffract different color components of the display light and/or display light from different fields of view. However, the achievable total refractive index modulations of a holographic material layer may be limited. Therefore, limited number of VBGs may be recorded in the holographic material layer, and the overall diffraction efficiency of VBG-based waveguide display systems may be low and/or the field of view of VBG-based waveguide display systema may be small.

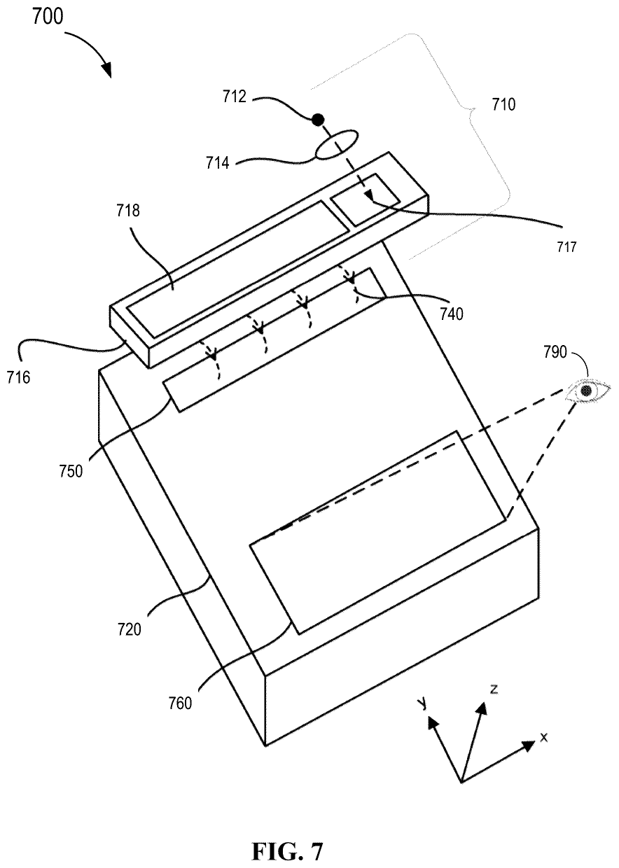

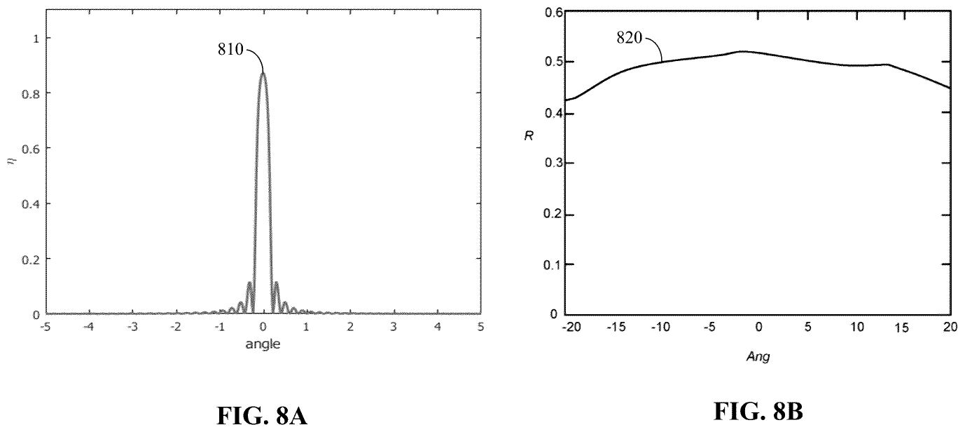

FIG. 8A includes a curve 810 illustrating the angular bandwidth of an example of a VBG (e.g., a transmission VBG). The horizontal axis in FIG. 8A represents the deviation of the incident angle of the visible light from a central (nominal) incident angle (the Bragg angle) that the VBG is designed for. The vertical axis in FIG. 8A represents the corresponding diffraction efficiency. As shown by curve 810, the diffraction efficiency of the VBG may only be relatively high for light incident on the grating from a narrow angular range around the perfect Bragg condition (the Bragg angle). Even though not shown in FIG. 8A, the diffraction efficiency of the VBG may also only be relatively high for incident light within a narrow wavelength range around the perfect Bragg condition.

Therefore, optical see-through near-eye display systems that employ waveguides and diffraction gratings (e.g., volume Bragg gratings (VBGs)) to present display images from a projector to user's eyes may have limited field of view (FOV) and spectrum coverage, due to, for example, the limited angular and spectral bandwidth of the diffraction gratings. Some diffraction gratings such as VBGs may have limited diffraction efficiencies due to, for example, the limited achievable refractive index modulation of the holographic recording material. In addition, multiple gratings used for one-dimensional or two-dimensional pupil expansion as described above with respect to FIG. 6A may perform multiple times of optical filtering (e.g., Bragg filtering due to limited bandwidths of the VBGs) on the display images, which may lead to optical artifacts such as intercepting optical line patterns that may reduce the quality of the display images. Furthermore, diffraction gratings may have large dispersion between light of different colors and may have different diffraction angles for light of different colors. Therefore, different color components in a color image displayed by the near-eye display system may not overlap with each other. As a result, the quality of the displayed image (e.g., resolution, contrast, and/or color reproduction neutrality) may be reduced. Moreover, the fields of view for different colors may be reduced or partially clipped due to the light dispersion and the limited range of wave vectors of the light that can be guided by the waveguide display.

In some implementations, an optical see-through near-eye display system may include a waveguide with one or more arrays of partially reflective mirrors embedded in multiple locations of the waveguide to direct display images from the multiple locations to user's eyes, thereby replicating the exit pupil and expanding the eyebox in one or two dimensions. The partially reflective mirrors may also be referred to as transflective mirrors, geometric mirrors, or geometric reflectors. A waveguide including transflective mirrors in the waveguide may be referred to as a geometrical waveguide. A transflective mirrors may split incident light by partially reflecting incident light and partially transmitting the incident light such that a portion of the incident light may continue to propagate within the waveguide to be split by other transflective mirrors. Such near-eye display systems may be referred to as geometrical waveguide display systems.

In some implementations, a near-eye display system may include a waveguide display that may include both diffraction gratings (e.g., VBGs) and transflective mirrors for two-dimensional pupil expansion. For example, either the VBGs or the transflective mirrors may be used to deflect, at multiple locations along a first direction, the display light from an input coupler (e.g., a prism, grating, or slanted mirror) towards a second direction to expand the pupil in one dimension (e.g., the first direction). Such VBGs or transflective mirrors may be referred to herein as the middle grating (or a first output grating). Display light deflected at multiple locations by the middle grating towards the second direction may reach an output grating, which may include either VBGs or transflective mirrors and may deflect an incident display light beam at multiple locations along the second direction towards an eye box of the near-eye display system, thereby expanding the pupil in a second dimension (e.g., the second direction). Such waveguide display systems may be referred to herein as hybrid waveguide display systems. The combination of diffraction gratings and partial reflective mirrors may lead to a hybrid spectral and angular coverage that may be broader than that of VBG-based waveguide display systems. This may lead to an improvement of the FOV and a reduction of undesired optical artifacts such as ghost images and intercepting optical line patterns.

Each transflective mirror used in geometrical waveguide display systems or hybrid waveguide display systems may include, for example, a plurality of dielectric coating layers, one or more metal coating layers, or a combination of dielectric coating layers and metal coating layers. For example, a transflective mirror may include a plurality of dielectric coating layers coated on a substrate, where the plurality of dielectric coating layers may include two or more different transparent dielectric materials having different refractive indices. The number of dielectric coating layers, and the refractive index and the thickness of each dielectric coating layer may be selected to achieve the desired performance, such as the desired reflectivity (reflection efficiency) and polarization performance. A plurality of substrates with a plurality of transflective mirrors formed thereon may be stacked and bonded (e.g., glued) together using, for example, optically clear adhesives. The bonded stack may be cut at a certain angle to form one or more geometrical waveguides each including a plurality of transflective mirrors embedded therein. Different transflective mirrors in the plurality of transflective mirrors may have different reflectivity efficiencies. For example, the reflectivity of a first transflective mirror that may receive the in-coupled display light before a second transflective mirror may have a lower reflectivity than the second transflective mirror, such that the portion of the display light reflected by the first transflective mirror may have a similar intensity as the portion of the display light reflected by the second transflective mirror.

FIG. 8B includes a curve 820 illustrating the angular bandwidth of an example of a transflective mirror. The horizontal axis in FIG. 8B represents the deviation of the incident angle of the visible light from a central (nominal) incident angle of the transflective mirror, and the vertical axis represents the corresponding reflectivity. In the example shown by curve 820, the reflectivity of the transflective mirror can be close to 50% (half-reflective half-transmissive) for light incident on the grating from a wide angular range around the central (nominal) incident angle. For example, the full-width half-magnitude (FWHM) reflection angular range of a transflective mirror may be greater than 40° or higher. Even though not shown in FIG. 8B, the reflectivity of the transflective mirror may also be high for incident light within a wide wavelength range.

As indicated by FIG. 8B, geometrical waveguide display systems or hybrid waveguide display systems using transflective mirrors may achieve large FOV, and may also have minimum or no color dispersion, and good image resolution and quality. However, geometrical waveguide display systems may be difficult and/or costly to make and may be difficult to achieve uniform light intensity within the eyebox. Imprecision in the processes of making individual transflective mirrors, stacking and bonding substrates with transflective mirrors coated thereon, and cutting the stack of substrates with transflective mirrors at a certain angle to form geometrical waveguides may lead to imperfections in the displayed images, such as black lines, nonuniformity in brightness, ghost images, and the like. For example, some geometrical waveguide display systems may have ghost stray rays and double imaging issues that may reduce the display quality. Some geometrical waveguide display systems may only achieve one-dimensional pupil expansion.

A geometrical waveguide may generally include a prism (as the input coupler) and two groups of geometrical reflectors to guide and expand display light to an eyebox. The prism may induce color dispersion that may often be difficult to fully compensate by partial reflective mirrors and the substrate along the light path. According to certain embodiments disclosed herein, a geometrical waveguide display may include 3 or 4 groups of geometrical reflectors to achieve full and complete color dispersion compensation, where the display light may interact with both input mirrors and output mirrors that have the same mirror orientations, and may interact with both a first group of middle mirrors and a second group of middle mirrors (or different regions of a same group of middle mirrors) that may have the same mirror orientations. The combination of multiple groups of mirrors can produce close to zero dispersion from waveguide input to waveguide output and the eyebox for visible light (e.g., red, green, and blue light) from all angles. The input mirror(s) may include a single mirror with reflectivity close to 100%, or a group of mirrors including one mirror with reflectivity close to 100% and one or more transflective mirrors with reflectivity less than 100%.

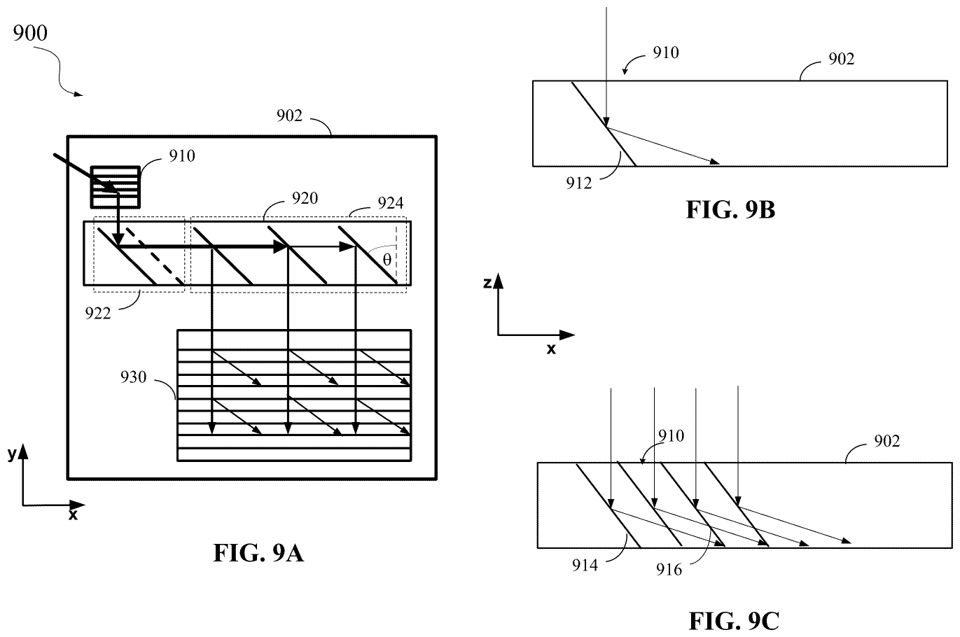

FIG. 9A illustrates an example of a waveguide display 900 including three or four groups of reflective and/or transflective mirrors for two-dimensional pupil expansion and dispersion compensation according to certain embodiments. Waveguide display 900 may be similar to waveguide display system 600, but may use reflective or transflective mirrors (rather than refractive or diffractive optical components) to replace input coupler 620, middle grating 630, and output grating 640. In the example illustrated in FIG. 9A, waveguide display 900 may include an input coupler 910 that may include one or more reflective and/or transflective mirrors and may be referred to as the input mirror. The input mirror may be used to couple display light into a waveguide 902 such that the display light may propagate within waveguide 902 through total internal reflection.

Waveguide display 900 may include a middle mirror 920 that may include a group of reflective and/or transflective mirrors having the same orientation. One or more reflective and/or transflective mirrors of middle mirror 920 may be used to direct display light from input coupler 910 towards other reflective and/or transflective mirrors of middle mirror 920, which may replicate the pupil in a first dimension (e.g., approximately the x direction) by reflecting portions of the display light at multiple locations along the first dimension as shown in FIG. 9A. For example, a first mirror and a last mirror (e.g., in x direction) in middle mirror 920 may be reflective mirrors with reflectivity close to 100%, and mirrors between the first mirror and the last mirror in middle mirror 920 may be transflective mirrors that have reflectivity less than 100% and are partially transmissive.

In some embodiments, middle mirror 920 may include a first middle mirror 922 and a second middle mirror 924. First middle mirror 922 may include one or more reflective and/or transflective mirrors that may direct display light from input coupler 910 towards second middle mirror 924. For example, the first mirror (e.g., in x direction) in first middle mirror 922 may be a reflective mirror with reflectivity close to 100% and other mirrors in first middle mirror 922 may be transflective mirrors that are partially transmissive. Second middle mirror 924 may include a plurality of reflective and/or transflective mirrors and may expand the pupil in a first dimension (e.g., approximately the x direction) by reflecting portions of the display light at multiple locations along the first dimension as shown in FIG. 9A. In one example, the last mirror (e.g., in x direction) in second middle mirror 924 may be a reflective mirror with reflectivity close to 100%, and other mirrors in second middle mirror 924 may be transflective mirrors that are partially transmissive.

Waveguide display 900 may also include an output mirror 930, which may include a plurality of reflective and/or transflective mirrors. As described above with respect to FIGS. 6A and 6B and shown in FIG. 9A, the transflective mirrors in output mirror 930 may reflect, at multiple locations along a second dimension (e.g., approximately the y direction), portions of the display light from each location of the multiple locations of middle mirror 920 to the eyebox to replicate the exit pupil in the second dimension. Therefore, middle mirror 920 and output mirror 930 may replicate the pupil in two-dimensions to fill the eyebox. In one example, the last mirror (e.g., in −y direction) in output mirror 930 may be a reflective mirror with reflectivity close to 100%, and other mirrors in output mirror 930 may be transflective mirrors that are partially transmissive.

As shown in FIG. 9A, input coupler 910 and output mirror 930 may have the same or similar orientations and may reflect light in opposite manners (e.g., into or out of waveguide 902), and thus may compensate the dispersion caused by each other to achieve dispersion-free pupil expansion. Similarly, a first portion of middle mirror 920 (or first middle mirror 922) and a second portion of middle mirror 920 (or second middle mirror 924) may have the same or similar orientations and may reflect light in opposite manners (e.g., from −y direction to x direction or form x direction to −y direction), and thus may compensate the dispersion caused by each other to achieve dispersion-free pupil expansion.

FIG. 9B shows an example of input coupler 910 that includes a mirror 912 according to certain embodiments. Mirror 912 may be oriented such that display light reflected by mirror 912 may propagate within waveguide 902 through total internal reflection. Mirror 912 may have a very high reflectivity, such as close to 100%, and may have a sufficiently large input aperture to receive the display light and achieve a high resolution for the waveguide display.

FIG. 9C shows another example of input coupler 910 that includes a mirror 914 and a plurality of transflective mirrors 916 according to certain embodiments. Mirror 914 and transflective mirrors 916 may be oriented such that display light reflected by the mirrors may propagate within waveguide 902 through total internal reflection. Mirror 914 may be similar to mirror 912 and may have a very high reflectivity, such as close to 100%. Transflective mirrors 916 may have reflectivity less than 100% and may be at least partially transmissive. Input coupler 910 that includes mirror 914 and transflective mirrors 916 may have a sufficiently large input aperture to receive the display light and achieve a high resolution for the waveguide display.

As described above with respect to, for example, FIG. 7, to reduce the size of a waveguide display, a long bar-shaped waveguide may be used to split the input display light into a one-dimensional (1-D) array of light beams along one direction (e.g., the length direction of the bar-shaped waveguide), thereby replicating the pupil in one dimension. A larger waveguide may receive the 1-D array of light beams and split each light beam into an array of light beams along another direction, thereby replicating the pupil in another dimension. Therefore, two-dimensional (2-D) pupil replication may be achieved by the combination of the bar-shaped waveguide and the larger waveguide to expand the eyebox. The bar-shaped waveguide may have a relatively small FOV in at least one dimension (e.g., a line FOV with about 0° FOV in a direction perpendicular to the length direction of the bar-shaped waveguide) to avoid reflections by sidewalls that may result in optical artifacts such as ghost images. A scanning mirror (e.g., a galvanometer mirror or microelectromechanical system (MEMS) mirrors) may be used to scan the array of light beams from the bar-shaped waveguide to increase the FOV in the dimension perpendicular to the length direction of the bar-shaped waveguide, to achieve a larger 2-D field of view. Using the scanning mirror may increase the size, complexity, and cost, and reduce the reliability and durability of the waveguide display.

According to certain embodiments, a kaleidoscopic waveguide may be used to replicate the pupil of a waveguide display in one dimension and also increase the FOV of the waveguide display, and thus a scanning mirror may not be used in the waveguide display. The kaleidoscopic waveguide may have a similar shape and size as the bar-shaped waveguides in waveguide displays that use scanning mirrors, but may be configured to guide the display light coupled into the kaleidoscopic waveguide in different manners. For example, display light coupled into a kaleidoscopic waveguide may be reflected by more than two surfaces of the kaleidoscopic waveguide, such as four surfaces of a kaleidoscopic waveguide having a rectangular cross-section, thereby creating multiple images of different parity in each round trip due to the reflection (e.g., including four reflections at the four surfaces due to total internal reflection). The kaleidoscopic waveguide can be configured such that the reflections by sidewalls may not cause optical artifacts or may only cause tolerable optical artifacts, and thus the FOV of the kaleidoscopic waveguide can be large in two dimensions. One or more of the multiple images covering a large 2-D FOV may be coupled out of the kaleidoscopic waveguide by, for example, a grating or transflective mirrors, through one surface of the kaleidoscopic waveguide towards a second waveguide. The second waveguide may replicate the exit pupil in another dimension to achieve 2-D pupil expansion. In this way, a waveguide display including a kaleidoscopic waveguide may have a small form factor and no moving parts (e.g., a scanning mirror), and may be able to achieve 2-D pupil expansion and a large 2-D FOV.

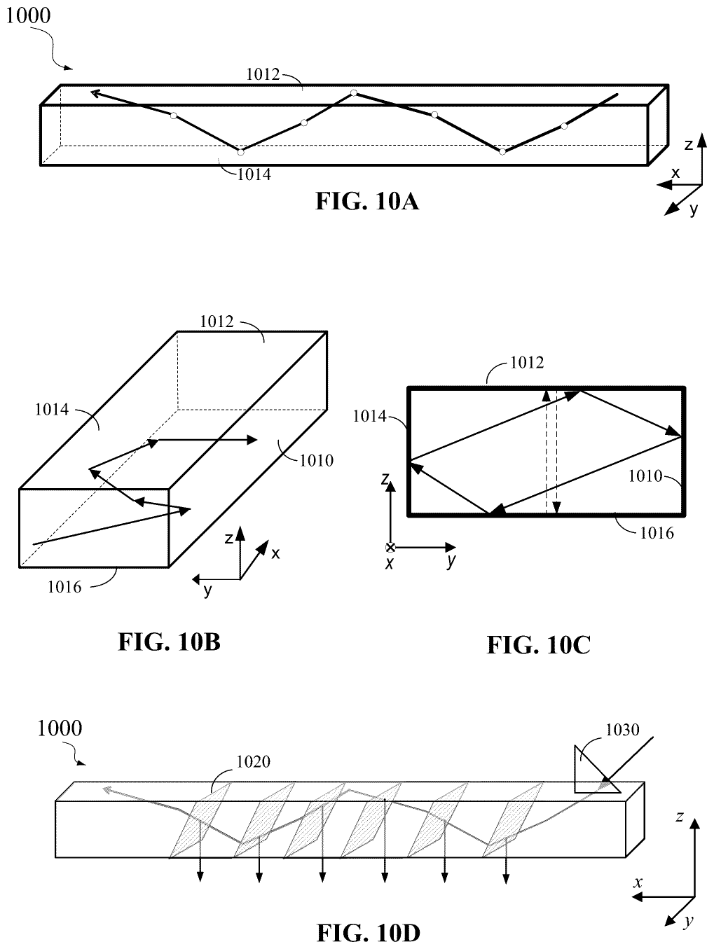

FIGS. 10A-10D illustrate an example of a kaleidoscopic waveguide 1000 for pupil expansion and 2-D FOV expansion in a waveguide display according to certain embodiments. Kaleidoscopic waveguide 1000 may be used as, for example, first waveguide 716 of waveguide display 700. In the illustrated example, kaleidoscopic waveguide 1000 may have a shape of long bar or tube (e.g., extending in the x direction) with a rectangular cross-section (e.g., in a y-z plane). Kaleidoscopic waveguide 1000 may include a material that is transparent to visible light as described above. Kaleidoscopic waveguide 1000, an input coupler (e.g., prism, grating, reflecting surface, etc.), and a projector (not shown in FIGS. 10A-10D) of the waveguide display may be arranged such that display light projected by the projector and coupled by the input coupler into kaleidoscopic waveguide 1000 may be incident on and reflected by four surfaces of kaleidoscopic waveguide 1000 that are parallel to the x direction through total internal reflection, such that the display light may propagate with in kaleidoscopic waveguide 1000 in approximately the x direction.

For example, in the embodiment illustrated in FIGS. 10A-10D, the display light coupled into kaleidoscopic waveguide 1000 may be incident on a side surface 1010 and reflected by side surface 1010 towards a bottom surface 1016 through total internal reflection. The display light incident on bottom surface 1016 may be reflected by bottom surface 1016 towards a side surface 1014 through total internal reflection. The display light incident on side surface 1014 may be reflected by side surface 1014 towards a top surface 1012 through total internal reflection. The display light incident on top surface 1012 may be reflected by top surface 1012 towards side surface 1010 through total internal reflection. In this way, when viewed in the x direction, the display light may be reflected by four surfaces of kaleidoscopic waveguide 1000 in each round trip as shown in FIG. 10C.

Kaleidoscopic waveguide 1000 may include one or more output couplers, such as a surface-relief grating, a holographic grating, transflective mirror (partially reflective mirrors), an array of micro-mirrors, and the like, as described in more detail below. The one or more output couplers may split the display light propagating within kaleidoscopic waveguide 1000 and couple portions of the display light out of kaleidoscopic waveguide 1000 at multiple locations through, for example, bottom surface 1016, thereby replicating the exit pupil in one dimension (e.g., the x direction). As first waveguide 716, kaleidoscopic waveguide 1000 may have a relatively large FOV in the dimension in which kaleidoscopic waveguide 1000 extends (e.g., the x direction). Due to the reflections at four surfaces of kaleidoscopic waveguide 1000 (rather than only the top and bottom surfaces) in each round trip, kaleidoscopic waveguide 1000 may also expand the field of view in a second dimension (e.g., the y direction).

FIG. 10D illustrates an example of kaleidoscopic waveguide 1000 including transflective mirrors 1020 for coupling display light out of kaleidoscopic waveguide 1000 according to certain embodiments. Kaleidoscopic waveguide 1000 may include a bar-shaped substrate. An input coupler 1030 (e.g., a prism, a wedge, a reflective surface, or a diffractive grating) may be configured to couple display light from a projector into kaleidoscopic waveguide 1000 at certain directions such that the display light may propagate within kaleidoscopic waveguide 1000 through total internal reflections at four surfaces of kaleidoscopic waveguide 1000 as described above. An array of transflective mirrors 1020 may be embedded in kaleidoscopic waveguide 1000 and may couple the display light guided by kaleidoscopic waveguide 1000 out of a bottom surface of kaleidoscopic waveguide 1000 at multiple locations along the x directions. In various embodiments, transflective mirrors 1020 may have any suitable shape and/or size, and may be fully embedded or partially embedded in kaleidoscopic waveguide 1000.

Transflective mirrors 1020 may be partially reflective and partially transmissive, and may split incident light by partially reflecting incident light and partially transmitting the incident light, such that a portion of the incident light may be reflected and coupled out of kaleidoscopic waveguide 1000, while a portion of the incident light may continue to propagate within the waveguide to be split by other transflective mirrors. Each transflective mirror 1020 may include, for example, a plurality of dielectric coating layers, one or more metal coating layers, or a combination of dielectric coating layers and metal coating layers. For example, a transflective mirror 1020 may include a plurality of dielectric coating layers coated on a substrate (e.g., a glass substrate), where the plurality of dielectric coating layers may include two or more different transparent dielectric materials having different refractive indices. The number of dielectric coating layers, and the refractive index and the thickness of each dielectric coating layer may be selected to achieve the desired performance, such as the desired reflectivity (reflection efficiency) and polarization performance. A plurality of substrates each with a transflective mirror 1020 formed thereon may be stacked and bonded (e.g., glued) together using, for example, optically clear adhesives. The bonded stack may be cut at a certain angle to form one or more geometrical waveguides each including a plurality of transflective mirrors 1020 embedded therein and having certain desired slant angles.

In some embodiments, different transflective mirrors 1020 in the array of transflective mirrors 1020 may have different reflectivity efficiencies. For example, the reflectivity of a first transflective mirror 1020 that may receive the display light before a second transflective mirror 1020 may have a lower reflectivity than the second transflective mirror 1020, such that the portion of the display light reflected by the first transflective mirror 1020 may have a similar intensity as the portion of the display light reflected by the second transflective mirror 1020. Transflective mirrors 1020 may have much wider angular and spectral bandwidths and may have higher efficiency than grating based couplers.

FIG. 11A illustrates an example of a geometrical waveguide display 1100. In the illustrated example, geometrical waveguide display 1100 may include a waveguide 1110, and multiple groups of transflective mirrors embedded in waveguide 1110. For example, the multiple groups of transflective mirrors may include input mirror(s) 1112, folding mirrors 1114, and output mirrors 1116. Input mirror(s) 1112 may couple incident light from a projector into waveguide 1110 and direct the in-coupled light towards folding mirrors 1114 through total internal reflection. Portions of the in-coupled light may be reflected by folding mirrors 1114 at multiple locations towards output mirrors 1116. Output mirrors 1116 may reflect each beam from folding mirrors 1114 at multiple locations towards the user's eye.

FIG. 11B illustrates examples of transflective mirrors in a geometrical waveguide display. The transflective mirrors may be tilted with respect to a surface or a surface-normal direction of the waveguide. The surface-normal direction of the transflective mirror is indicated by a vector î. The incident angle of incident light may be the angle with respect to vector n.

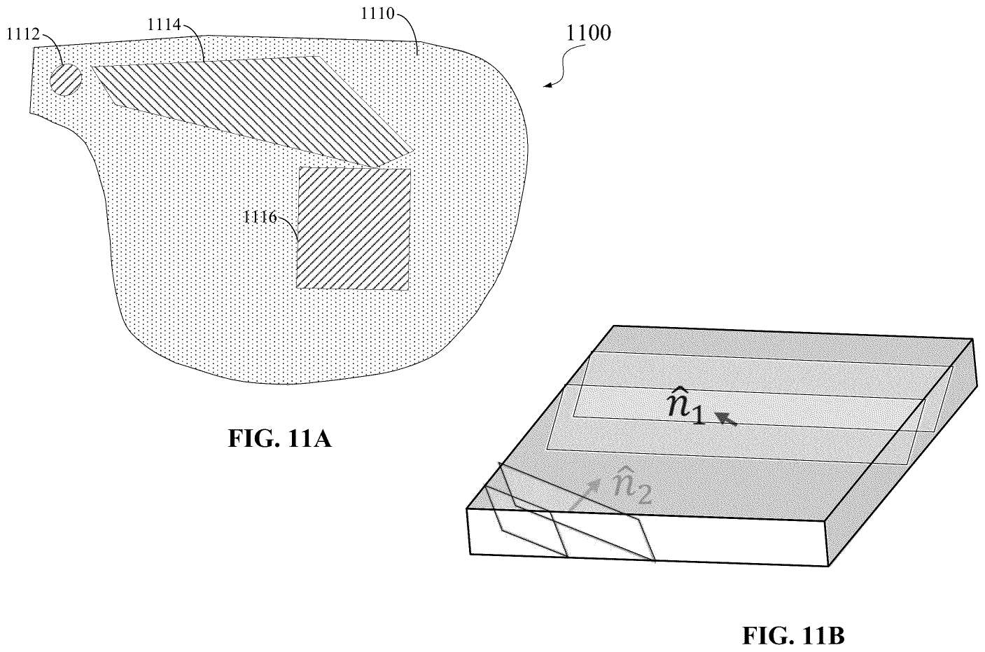

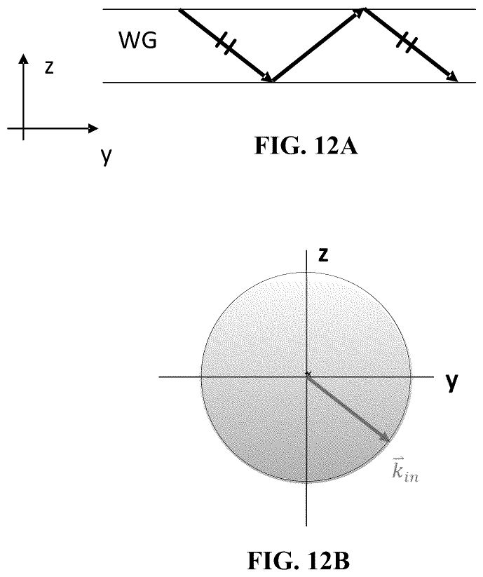

FIG. 12A illustrates an example of a light beam propagating in an example of a waveguide. The light beam may be reflected by the top and bottom surfaces of the waveguide through total internal reflection as described above. The light beam propagating within the waveguide may be incident on transflective mirrors formed in the waveguide. FIG. 12A shows the component of the light beam projected onto a y-z plane, where the light beam may be propagating in direction that has components in the x, y, and z directions.

FIG. 12B illustrates an example of a k-vector (\vec{k}ᵢₙ) representing the wave vector of a light beam propagating in a waveguide and incident on a transflective mirror. The length of k-vector \vec{k}ᵢₙ may be about 2π/λ, and the direction of k-vector \vec{k}ᵢₙ may be the propagation direction of the light beam. FIG. 12B shows the k-vector projected onto a y-z plane of the k-sphere.

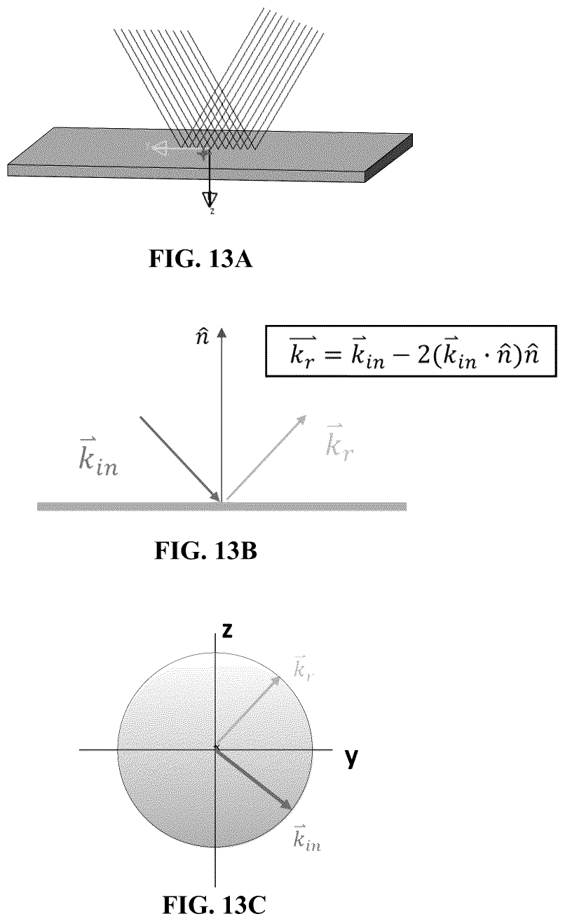

FIG. 13A illustrates an example of a light beam reflected by a specular reflector. FIG. 13B illustrates the wave vectors of the incident light beam and the reflected light beam shown in FIG. 13A. FIG. 13C illustrates the wave vectors (k-vectors) of the incident light beam and the reflected light beam of FIG. 13A in k-space. In the example illustrated in FIGS. 13A-13C, the k-vector of the incident beam is \vec{k}ᵢₙ, the k-vector of the reflected beam is \vec{k}ᵣ, and the surface-normal direction of the specular mirror is \hat{n}, where the k-vector \vec{k}ᵣ of the reflected beam may be determined according to:

$${\vec{k}}_{r} = {\vec{k}}_{i n} - 2 ( {\vec{k}}_{i n} \cdot \hat{n} ) \hat{n} .$$

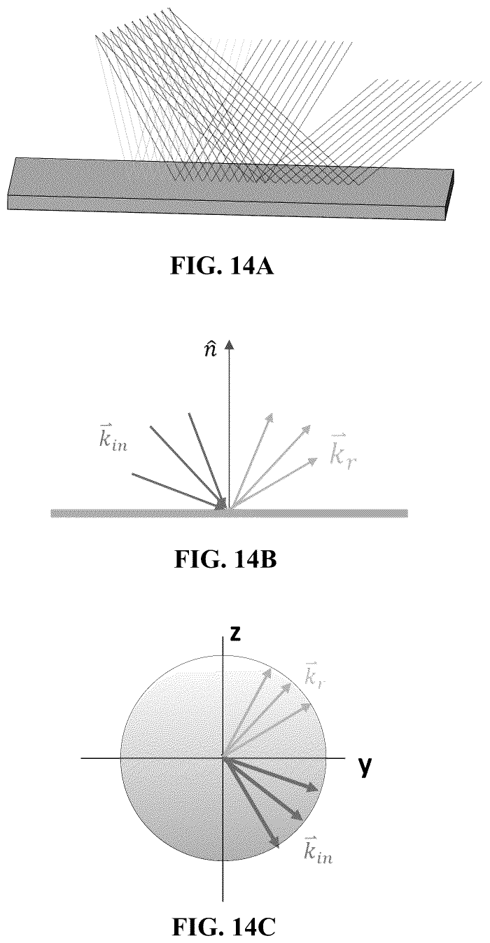

FIG. 14A illustrates an example of light beams from different fields of view (e.g., in a light frustum) reflected by a specular reflector. FIG. 14B illustrates the k-vectors of the incident light beams and the reflected light beams shown in FIG. 14A. FIG. 14C illustrates the k-vectors of the incident light beams and the reflected light beams of FIG. 14A in k-space.

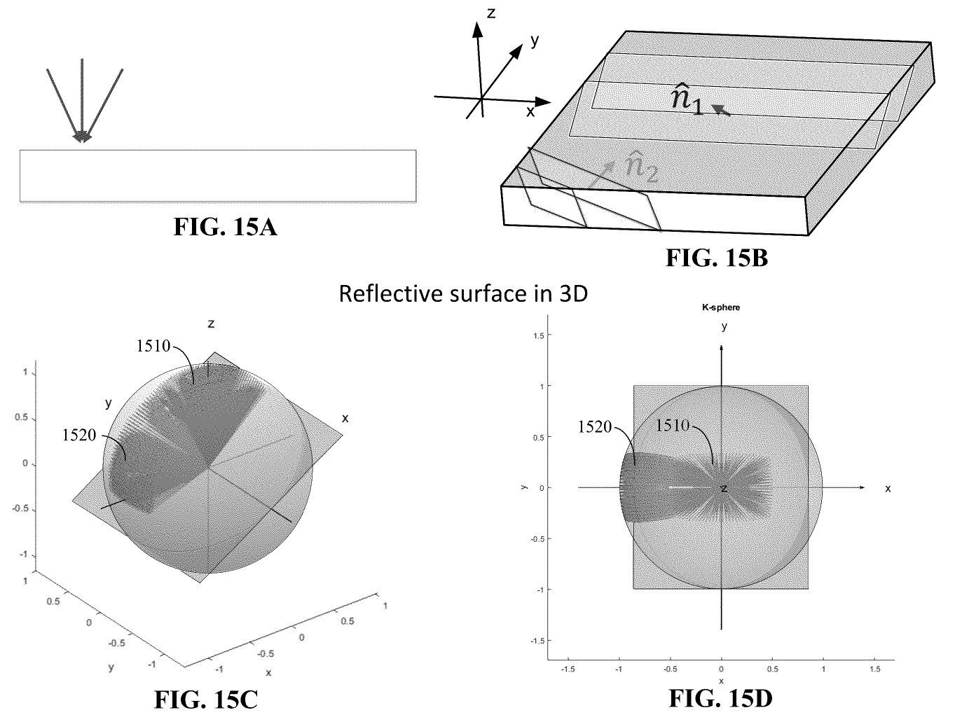

FIG. 15A illustrates an example of a light beam in a frustum (e.g., a 60×40° frustrum) incident on a geometrical waveguide display. The light beam in the frustum may include light from different fields of view and thus may be incident on the geometrical waveguide display from many different angles.

FIG. 15B illustrates orientations of examples of transflective mirrors in the example of the geometrical waveguide display. For example, the surface-normal direction of some mirrors may be represented by a vector [symbol] , and the surface-normal direction of some mirrors may be represented by a vector [symbol] .

FIG. 15C illustrates k-vectors of the incident light and k-vectors of the light reflected by a transflective mirror of the geometrical waveguide display of FIG. 15B in a k-sphere. FIG. 15C shows a 3-D view of the k-sphere and the k-vectors. FIG. 15D illustrates k-vectors of the incident light and k-vectors of the light reflected by a transflective mirror of the geometrical waveguide display of FIG. 15B in a k-sphere, as projected onto a plane (e.g., an x-y plane). In FIGS. 15C and 15D, K-vectors 1510 represent the incident light in the incident frustum and may be collectively referred to as an input k-frustum. K-vectors 1520 represent the reflected light in the reflected frustum and may be referred to as an output k-frustum.

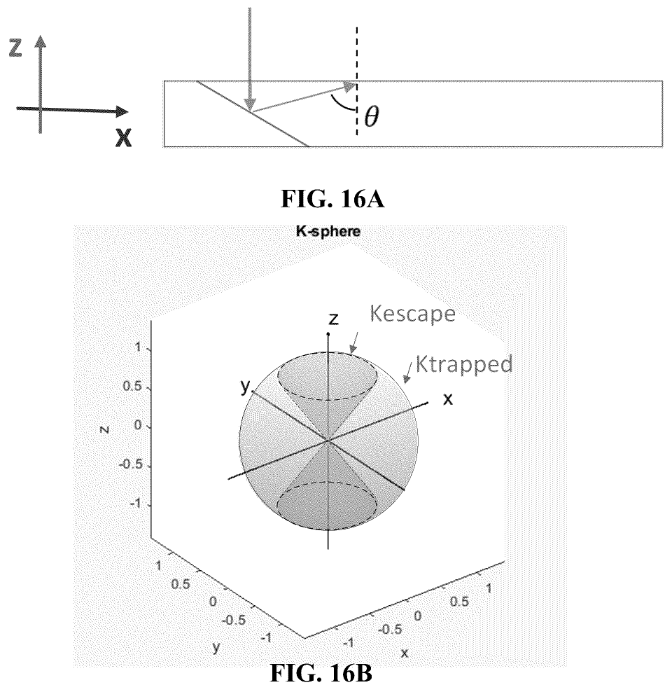

FIG. 16A illustrates the orientation of a transflective mirror in an example of a geometrical waveguide display. FIG. 16A shows that surface-normal incident light may enter the waveguide and reflected by the transflective mirror. The light reflected by the transflective mirror may be incident on a surface of the waveguide at an incident angle θ, which may be greater than critical angle at the interface between the waveguide and air, and thus may be totally internally reflected by the surface of the waveguide and become guided wave within the waveguide.

FIG. 16B illustrates k-vectors in a k-sphere indicating light that may be guided by the geometrical waveguide display of FIG. 16A. In the k-sphere shown in FIG. 16B, k-vectors within the two cones centered around the z axis represent k-vectors of light that may be refracted out of the waveguide because the incident angles (with respect to the z direction) may be smaller than the critical angle. K-vectors in other regions of the k-sphere represent light that may be trapped in the waveguide due to total internal reflection.

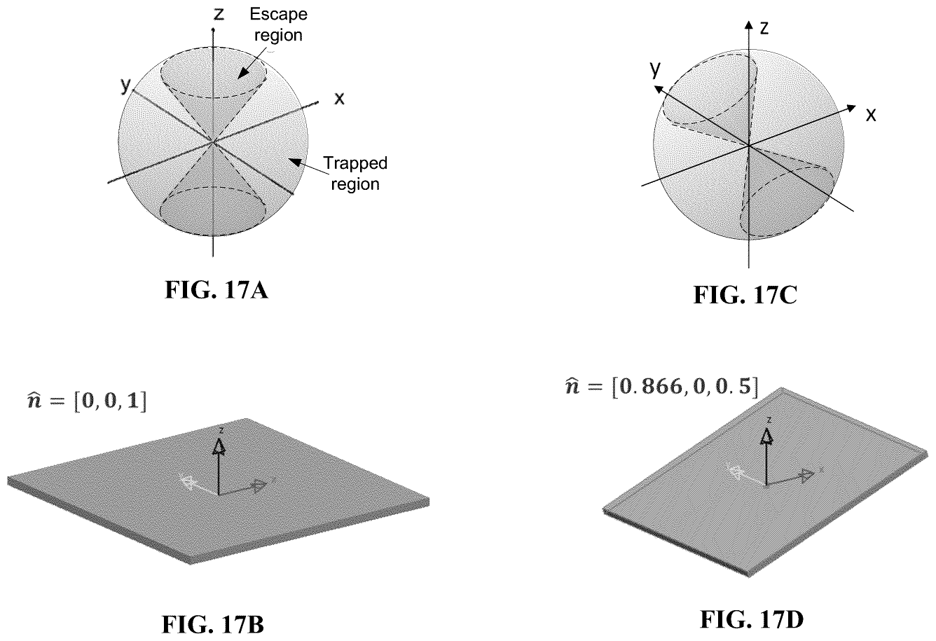

FIGS. 17A-17B illustrate critical cones in a k-sphere indicating light that may be guided by a geometrical waveguide display having a surface-normal direction (\hat{n}=[0, 0, 1]) in a vertical direction (e.g., z direction). As described above with respect to FIG. 16B, k-vectors within the two cones centered around the z axis represent k-vectors of light that may be refracted out of the waveguide because the incident angles (with respect to the z direction) may be smaller than the critical angle. K-vectors in other regions of the k-sphere represent light that may be trapped in the waveguide due to total internal reflection.

FIGS. 17C-17D illustrate critical cones in a k-sphere indicating light that may be guided by a tilted geometrical waveguide display (with a surface-normal direction tilted with respect to a vertical direction). In the illustrated example, the surface-normal direction of the waveguide is \hat{n}=[0.866, 0, 0.5] in the x-y-z space. Thus, the cones representing the k-vectors of light that may be refracted out of the waveguide are not centered around the z axis, but may be centered around a direction represented by vector î=[0.866, 0, 0.5].

The 3-D k-vector analysis technique disclosed herein can be used to analyze light propagation in various waveguide displays, such as 1-D geometrical waveguide combiner, 2-D geometrical waveguide displays, geometrical waveguide displays with folded 2-D pupil expansion using kaleidoscopic geometrical waveguides, waveguide displays using both geometrical waveguides and diffractive waveguides (e.g., including grating couplers), and the like.

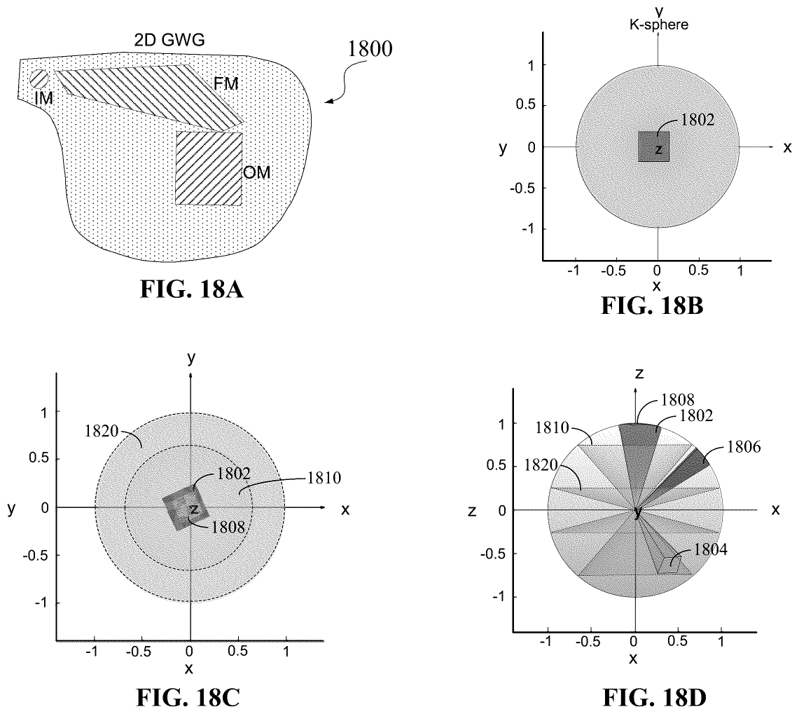

FIG. 18A illustrates an example of a geometrical waveguide display 1800 including multiple groups of mirrors for pupil expansion. Geometrical waveguide display 1800 may be similar to geometrical waveguide display 1100, and may include a waveguide and multiple groups of transflective mirrors embedded in the waveguide, such as input mirror(s), folding mirrors, and output mirrors as described above. The 3-D k-vector analysis technique disclosed herein may be used to trace the light frustrum after each reflection by a mirror, and determine if the light frustrum can be supported (e.g., guided) by the waveguide, if there may be any potential ghost path, if the potential ghost path can be eliminated, what is the largest FOV that the waveguide display can support, what is the tradeoff between refractive index of the waveguide and the FOV of the waveguide display, and the like.

FIG. 18B illustrates k-vectors of an input light beam 1802 of geometrical waveguide display 1800 projected onto a plane (e.g., an x-y plane) of a k-sphere. In the illustrated example, input light beam 1802 may be in a frustum that is about 30° wide (diagonally) and has a cant angle about −3°.

FIG. 18C illustrates k-vectors of input light beam 1802 and the corresponding output light beam 1808 of geometrical waveguide display 1800 projected onto a plane (e.g., an x-y plane) of a 3-D k-sphere. FIG. 18D illustrates the k-vectors of input light beam 1802, a light beam 1804 reflected by an input mirror, a light beam 1806 reflected by a folding mirror, and the corresponding output light beam 1808 of geometrical waveguide display 1800 being projected onto a plane (e.g., an x-z plane) of a 3-D k-sphere. In the illustrated example, cones 1810 represent k-vectors of light that may be refracted out of the waveguide (not supported by the waveguide), and cones 1820 represent k-vectors of light that may have very large incident angle (e.g., >75°) and thus may be reflected fewer times by the waveguide (and thus the display may have a lower pupil density in the eyebox) and should be avoided. Therefore, it may be desirable that the k-vectors of the light propagating within geometrical waveguide display 1800 are in regions between cones 1810 and cones 1820.

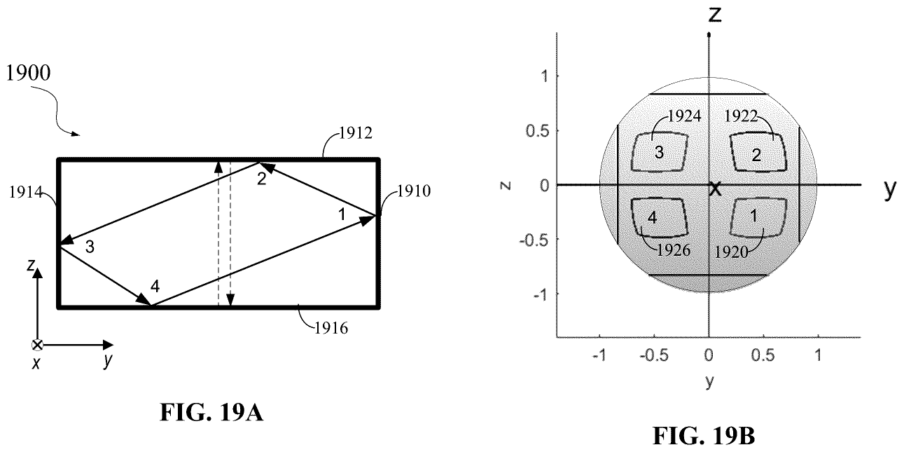

FIG. 19A illustrates light reflections by four surfaces of an example of a kaleidoscopic waveguide 1900 according to certain embodiments. Kaleidoscopic waveguide 1900 may be an example of kaleidoscopic waveguide 1000 described above with respect to FIGS. 10A-10D. FIG. 19B illustrates an example of analyzing kaleidoscopic waveguide 1900 using k-vectors in a 3-D k-sphere according to certain embodiments. FIG. 19B shows the k-vectors of display light being reflected by the four surfaces of kaleidoscopic waveguide 1900 of FIG. 19A through total internal reflection according to certain embodiments. In the illustrated example, incident light coupled into kaleidoscopic waveguide 1900 and propagating in approximately the x direction may be reflected at a side surface 1910 of kaleidoscopic waveguide 1900 by a first total internal reflection, and the corresponding wave vectors k (in the y-z plane) of the display light reflected by the first total internal reflection may be shown by a first region 1920 in the y-z plane of the k-space. Display light reflected by the first total internal reflection may then be reflected at a top surface 1912 of kaleidoscopic waveguide 1900 by a second total internal reflection, and the corresponding wave vectors k (in the y-z plane) of the display light reflected by the second total internal reflection may be shown by a second region 1922 in the y-z plane of the k-space. Display light reflected by the second total internal reflection may subsequently be reflected at a side surface 1914 of kaleidoscopic waveguide 1900 by a third total internal reflection, and the corresponding wave vectors k (in the y-z plane) of the display light reflected by the third total internal reflection may be shown by a third region 1924 in the y-z plane of the k-space. Display light reflected by the third total internal reflection may subsequently be reflected at a bottom surface 1916 of kaleidoscopic waveguide 1900 by a fourth total internal reflection, and the corresponding wave vectors k (in the y-z plane) of the display light reflected by the fourth total internal reflection may be shown by a fourth region 1926 in the y-z plane of the k-space. At each reflection, the parity of the image may be changed. As such, four copies of the display image with different parity may be created by the reflections at the four surfaces in each round trip. For example, display images after the first reflection and the second reflection may have opposite parity, display images after the first reflection and the third reflection may have the same parity, while display images after the second reflection and the fourth reflection may have the same parity.

FIG. 19A also shows the reflection of the display light by only the top and bottom surfaces of a bar-shaped waveguide, where the display light may propagate within the waveguide in the z direction in addition to the x direction and may have a line FOV (e.g., with an FOV about 0° in the y direction). In contrast, in kaleidoscopic waveguide 1900, the display light may propagate within the waveguide in both the y and z directions (in addition to the x direction) in each round trip. Kaleidoscopic waveguide 1900 can be configured such that the reflections by sidewalls can be tolerated, and thus the FOV of kaleidoscopic waveguide 1900 does not need to be a line FOV to avoid reflections by sidewalls and can be large in the y direction as well. As such, the FOV of the display light guided by kaleidoscopic waveguide 1900 may be expanded in the y direction.

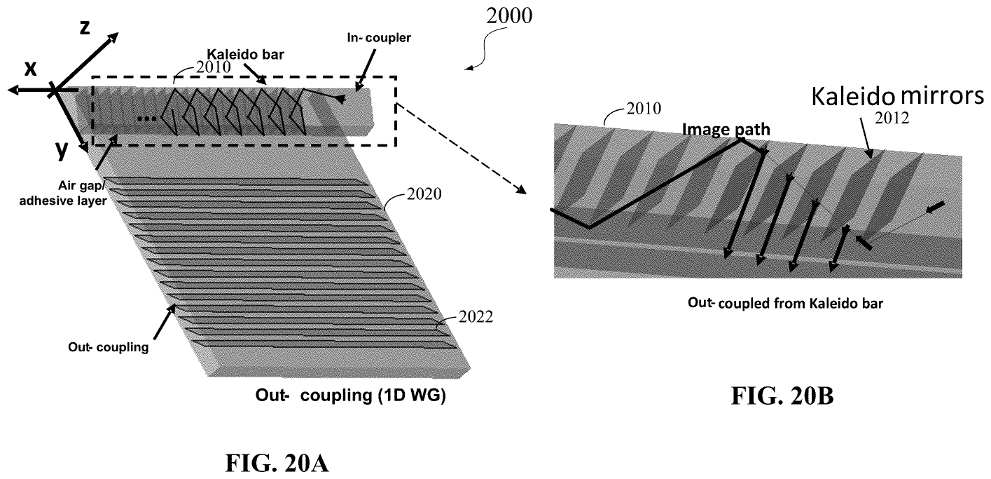

FIGS. 20A and 20B illustrate an example of a geometrical waveguide display 2000 including a kaleidoscopic waveguide for pupil expansion and 2-D FOV expansion according to certain embodiments. Geometrical waveguide display 2000 may include a first waveguide 2010 and a second waveguide 2020, where first waveguide 2010 may be adjacent to one edge or on top of an input region of second waveguide 2020 and may be positioned at a certain orientation (e.g., with edges aligned or at a certain angle) with respect to second waveguide 2020. First waveguide 2010 may be a kaleidoscopic waveguide including an input coupler and an output coupler as described above, and may extend in a first direction (e.g., the x direction). Display light from a projector may be coupled into first waveguide 2010, and may propagate within first waveguide 2010 in the first direction (e.g., the x direction) due to total internal reflection at four surfaces of first waveguide 2010 that are parallel to the first direction (e.g., the x direction). The display light propagating within first waveguide 2010 may be coupled out of first waveguide 2010 by an output coupler (e.g., an array of transflective mirrors 2012) at multiple locations along the first direction (e.g., the x direction) to replicate the exit pupil in the first direction.

In the illustrated example, the display light coupled out of first waveguide 2010 at each of the multiple locations along the first direction may be coupled into second waveguide 2020 at an edge of second waveguide 2020. The display light coupled into second waveguide 2020 may propagate within second waveguide 2020 in a second direction (e.g., the y direction), and may be coupled out of second waveguide 2020 by an array of transflective mirrors 2022 at multiple locations along approximately the second direction (e.g., the y direction) so as to replicate the exit pupil in the second direction. Geometrical waveguide display 2000 may be analyzed using the 3-D k-vector analysis techniques disclosed herein.

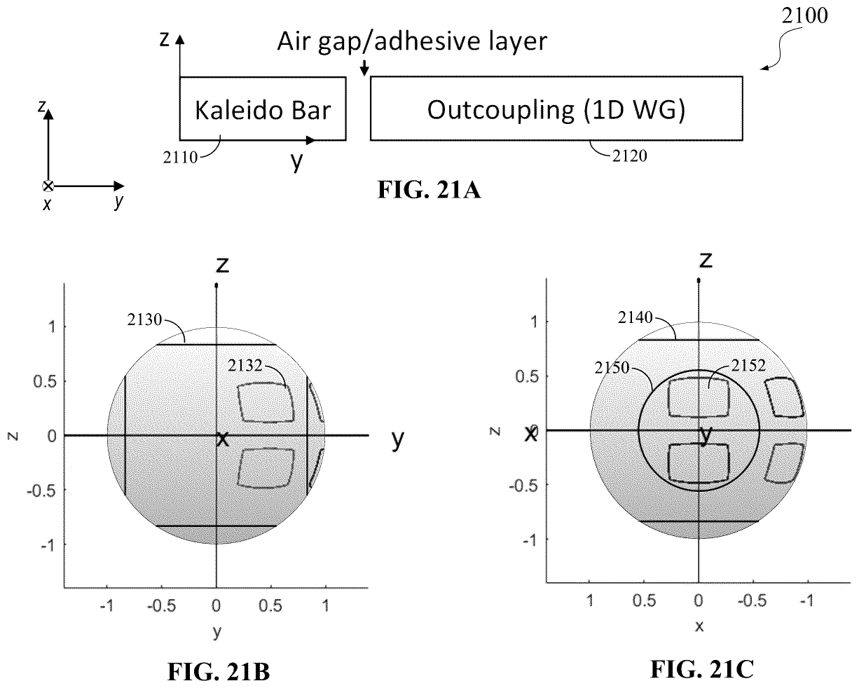

FIG. 21A illustrates an example of a geometrical waveguide display 2100 including a kaleidoscopic waveguide 2110 according to certain embodiments. Geometrical waveguide display 2100 may be an example of geometrical waveguide display 2000. In the illustrated example, kaleidoscopic waveguide 2110 may be positioned side-by-side with an output waveguide 2120, where the output surface of kaleidoscopic waveguide 2110 may be parallel to the input surface of output waveguide 2120 and there may be air or another low refractive index material between kaleidoscopic waveguide 2110 and output waveguide 2120 to cause total internal reflection. Both kaleidoscopic waveguide 2110 and output waveguide 2120 may include embedded transflective mirrors. In the illustrated example, the transflective mirrors in kaleidoscopic waveguide 2110 may be oriented at an angle about 60° with respect to a surface (e.g., in an x-y plane) of kaleidoscopic waveguide 2110.

FIG. 21B illustrates k-vectors of light reflected by the geometrical mirrors of kaleidoscopic waveguide 2110 of FIG. 21A, where the k-vectors may be projected onto a plane (e.g., a y-z plane) of a k-sphere. In FIG. 21B, the center region between lines 2130 represents k-vectors of light that may be guided by kaleidoscopic waveguide 2110, whereas regions 2132 may represent k-vectors of light that may be reflected by a transflective mirror in kaleidoscopic waveguide 2110. FIG. 21B shows that the light reflected by the transflective mirror may continue to be guided by kaleidoscopic waveguide 2110 and may not be coupled out through a y-z plane (e.g., top and bottom surfaces of kaleidoscopic waveguide 2110).

FIG. 21C illustrates k-vectors of light reflected by the geometrical mirrors of kaleidoscopic waveguide 2110 of FIG. 21A, where the k-vectors may be projected onto a plane (e.g., an x-z plane) of a k-sphere. In FIG. 21C, the region between line 2140 and a circle 2150 represents k-vectors of light that may be guided by kaleidoscopic waveguide 2110, and circle 2150 may represent k-vectors of light that may be coupled out of kaleidoscopic waveguide 2110. Regions 2152 represent k-vectors of light that may be reflected by the transflective mirror in kaleidoscopic waveguide 2110. FIG. 21C shows that two regions 2152 may fall within circle 2150, and thus some light reflected by the transflective mirror may be coupled out of kaleidoscopic waveguide 2110 through an x-z plane (e.g., the edge adjacent to output waveguide 2120).

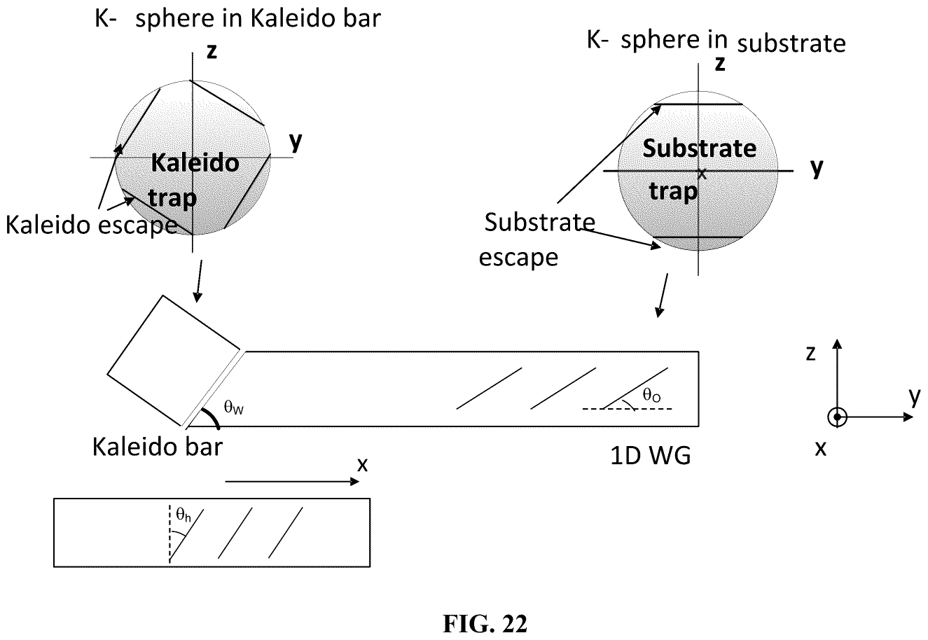

FIG. 22 illustrates k-vectors of light that may be guided by waveguides of a geometrical waveguide display including a kaleidoscopic waveguide. The geometrical waveguide display shown in FIG. 22 includes a kaleidoscopic waveguide and an output waveguide that may have a wedge angle θ_{w}. The kaleidoscopic waveguide may be positioned at the wedge of the output waveguide. The transflective mirrors in the kaleidoscopic waveguide may be tilted at angle θₙ (in a x-z plane) within the kaleidoscopic waveguide. The transflective mirrors in the output waveguide may be tilted at angle θₒ within the output waveguide.

FIG. 22 also shows the k-sphere in the kaleidoscopic waveguide and the k-sphere in the output waveguide. In the k-sphere in the kaleidoscopic waveguide, the center region may represent the k-vectors of light that may be guided by the kaleidoscopic waveguide, while the four edge regions may represent the k-vectors of light that may not be guided by the kaleidoscopic waveguide. In the k-sphere in the output waveguide, the center region may represent the k-vectors of light that may be guided by the surfaces of output waveguide in y-z planes, while the top and bottom regions may represent the k-vectors of light that may escape the output waveguide from the surfaces in the y-z plane.

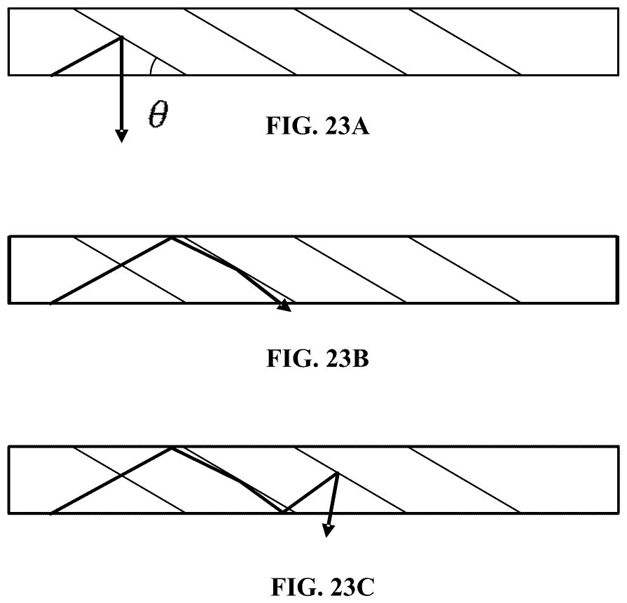

FIGS. 23A-23C illustrate examples of light reflection by various mirrors of a geometrical waveguide display. FIG. 23A shows an example of guided light reflected and coupled out of the geometrical waveguide by a transflective mirror. FIG. 23B shows an example of guided light reflected by a top surface and a transflective mirror of the geometrical waveguide display. FIG. 23C shows an example of guided light reflected by surfaces of the geometrical waveguide display and transflective mirrors of the geometrical waveguide display.

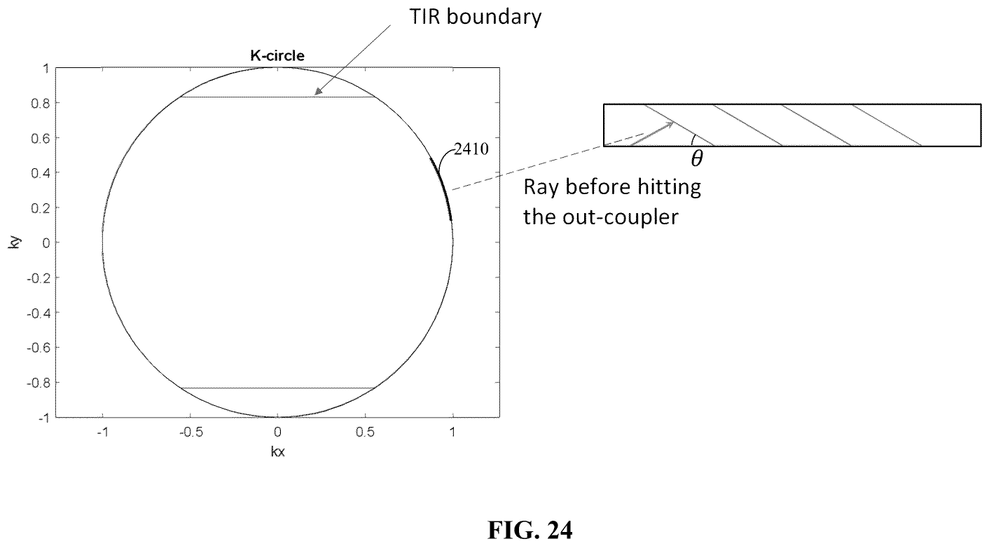

FIG. 24 illustrates k-vectors of an example of a light frustum propagating within a geometrical waveguide. FIG. 24 shows the k-vectors of the light frustum projected onto an x-y plane (a k-circle), where an arc 2410 on a k-circle represents light guided by the geometrical waveguide and incident on a transflective mirror. In the illustrated example, the transflective mirrors in the geometrical waveguide may be tilted at angle θ=36° with respect to the top or bottom surface of the waveguide, and the refractive index of the waveguide may be above 1.8. The geometrical waveguide may support a FOV about ±20° or larger.

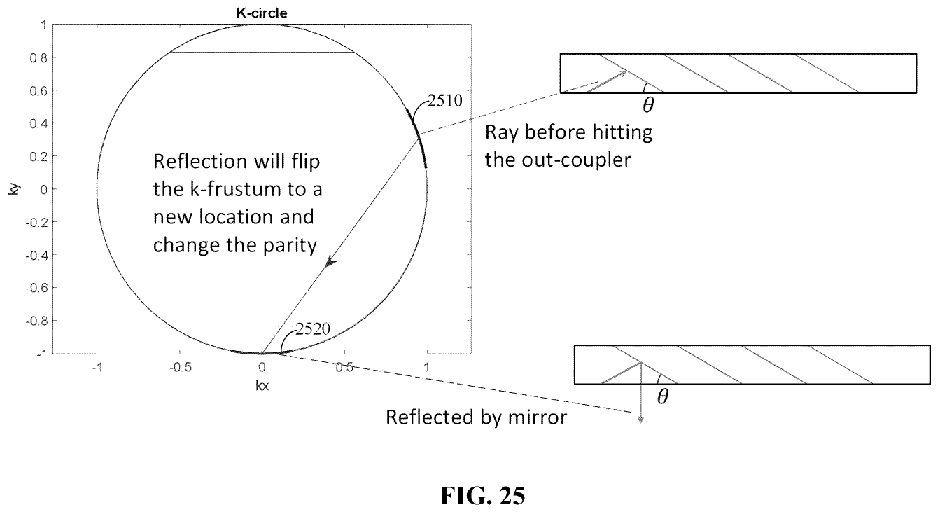

FIG. 25 illustrates k-vectors of an example of a light frustum propagating within a geometrical waveguide and an example of a light frustum reflected by a transflective mirror of the geometrical waveguide. FIG. 25 shows the k-vectors projected onto an x-y plane (a k-circle), where an arc 2510 on the k-circle represents light guided by the geometrical waveguide and incident on a transflective mirror, and an arc 2520 on the k-circle represents light reflected by the transflective mirror. Arc 2520 is at a bottom region of the k-circle, which indicates that the light reflected by the transflective mirror may not be guided by the waveguide and thus may be refracted out of the waveguide.

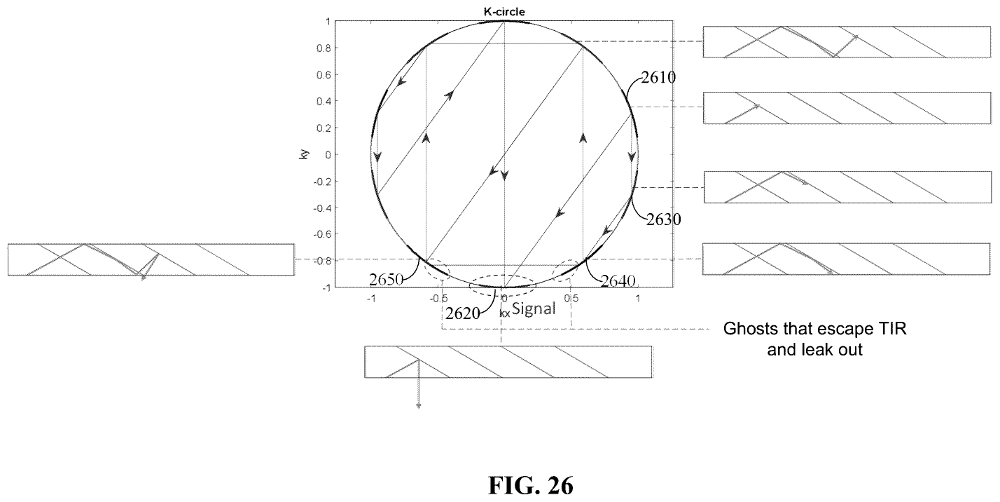

FIG. 26 illustrates k-vectors of light frustums propagating within a geometrical waveguide and reflected by mirrors and surfaces of the geometrical waveguide. FIG. 25 shows the k-vectors projected onto an x-y plane (a k-circle). In the illustrated example, the transflective mirrors in the geometrical waveguide may be tilted at angle θ=180/5=36° with respect to the top or bottom surface of the waveguide. In the k-circle shown in FIG. 26, slanted lines with arrows indicate reflection by transflective mirrors, while vertical lines with arrows indicate reflection by the top and/or bottom surfaces of the waveguide. As described above, the light frustum may change parity each time it is reflected, as indicated by the different colors of the arcs on the k-circle. In FIG. 26, arcs in a same color represents images having a same parity.

In FIG. 26, an arc 2610 on the k-circle represents light guided by the geometrical waveguide and incident on a transflective mirror. An arc 2620 on the k-circle represents light guided by the geometrical waveguide and reflected by the transflective mirror, where arc 2620 falls outside of the center region that represents the k-vectors of light that can be guided by the waveguide. Therefore, the reflected light represented by arc 2620 may be coupled out of the waveguide towards the user's eye to display an image to the user. An arc 2630 on the k-circle represents the light frustum reflected by the top surface of the waveguide. An arc 2640 on the k-circle represents the light frustum reflected by the top surface of the waveguide and then reflected by a transflective mirror. In the illustrated example, a portion of arc 2640 may fall outside of the center region that represents the k-vectors of light that can be guided by the waveguide. Therefore, a portion of the reflected light may be coupled out of the waveguide, and may form a ghost image that has the opposite parity compared to the displayed image. An arc 2650 on the k-circle represents the light frustum reflected by the top surface of the waveguide, a first transflective mirror, the bottom surface of the waveguide, and a second transflective mirror. In the illustrated example, a portion of arc 2650 may fall outside of the center region that represents the k-vectors of light that can be guided by the waveguide. Therefore, a portion of the reflected light may be coupled out of the waveguide, and may form a ghost image that has an opposite parity compared to the displayed image indicated by arc 2620.

In the example shown in FIG. 26, the transflective mirrors in the geometrical waveguide may be tilted at angle θ that is equal to 180°/N (e.g., 180/5=36°) with respect to the top or bottom surface of the waveguide. Therefore, an arc representing a light frustum may fall on the same position (with the same parity) after 2N times of reflection. Therefore, there may be finite number of possible images (light frustums) in the waveguide.

In addition, as shown by arc 2620, arc 2640, and arc 2650, the two ghost images (represented by arc 2640 and arc 2650) closest to the displayed image (represented by arc 2620) may be located symmetrically with respect to (having equal distance from) the displayed image. Therefore, the supported FOV can be maximized and can avoid signal-ghost overlapping. In some embodiments, the waveguide may have a high refractive index, and the two ghost images may be inside TIR boundary and thus may be trapped with the waveguide. Therefore, no ghost images may reach user's eyes. Some ghost images may be generated by many reflections and may have intensities that may be negligible compared with the displayed image.

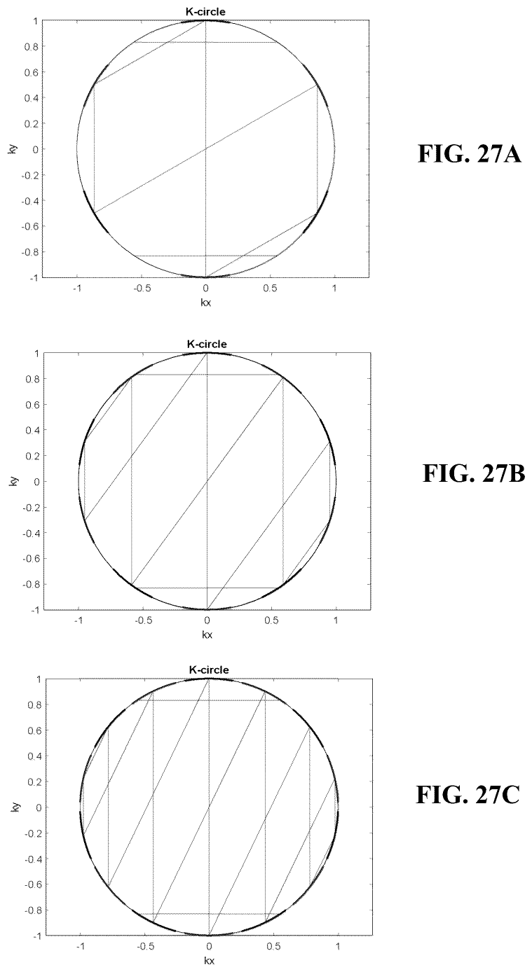

FIG. 27A illustrates k-vectors of light beams in a light frustum propagating within an example of a geometrical waveguide and reflected by surfaces and transflective mirrors having a first orientation (e.g., about 180/3=60° with respect to a surface of the geometrical waveguide) in the geometrical waveguide. As illustrated, when the tilt angle of the transflective mirrors is 180/N, where N is an odd number, there may be 2N arcs evenly distributed on the k-circle and representing light frustums reflected by mirrors and surfaces of the waveguide. In the example shown in FIG. 27A, N=3, and there may be 6 different light frustums reflected by transflective mirrors and surfaces of the waveguide. FIG. 27A shows that the waveguide may support a large FOV, without causing ghost images that may overlap the displayed images, even when the refractive index of the waveguide is lower.

FIG. 27B illustrates k-vectors of light beams propagating within an example of a geometrical waveguide and reflected by surfaces and transflective mirrors having a second orientation (e.g., about 180/5=36° with respect to a surface of the geometrical waveguide) in the geometrical waveguide. In the example shown in FIG. 27B, N=5, and there may be 10 different light frustums reflected by transflective mirrors and surfaces of the waveguide. Therefore, the FOV supported by the waveguide display may be smaller than that of the waveguide display shown in FIG. 27A. FIG. 27B shows that k-frustums of the two ghost images closest to the displayed image may be located symmetrically with respect to (having equal distance from) the k-frustum of the displayed image. Therefore, the supported FOV may be increased, without causing signal-ghost overlapping.

FIG. 27C illustrates k-vectors of light beams propagating within an example of a geometrical waveguide and reflected by surfaces and transflective mirrors having a third orientation (e.g., about 180/7=25.7° with respect to a surface of the geometrical waveguide) in the geometrical waveguide. In the example shown in FIG. 27C, N=7, and there may be 14 different light frustums reflected by mirrors and surfaces of the waveguide. Therefore, the FOV supported by the waveguide display may be smaller than that of the waveguide display shown in FIG. 27B. FIG. 27C shows that the k-frustums of the two ghost images closest to the displayed image may be located symmetrically with respect to (having equal distance from) the k-frustum of the displayed image. Therefore, the supported FOV may be optimized to avoid signal-ghost overlapping.

FIGS. 27A-27C show that, when the mirrors are tilted at an angle equal to 180°/N, where N is an odd number, k-frustums of the two ghost images closest to the displayed image may be located symmetrically with respect to (having equal distance from) the k-frustum of the displayed image. Therefore, the supported FOV can be optimized, without causing signal-ghost overlapping. FIGS. 27A-27C also show that, when N is smaller, lager FOVs may be supported by the waveguide display, and the ghost images may be trapped in the waveguide, even if the refractive index of the waveguide is lower.

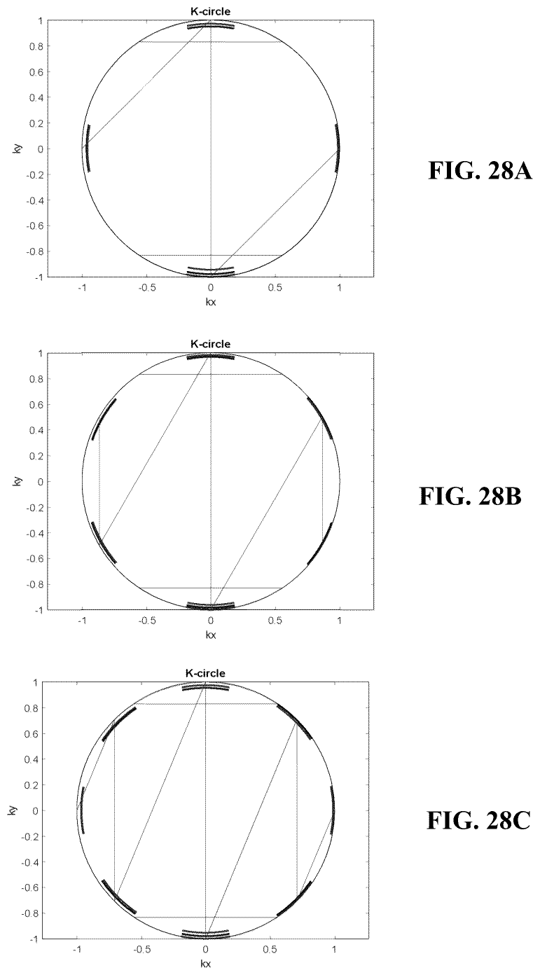

FIG. 28A illustrates k-vectors of light beams propagating within an example of a geometrical waveguide and reflected by surfaces and transflective mirrors having a first orientation in the geometrical waveguide. In the example shown in FIG. 28A, the transflective mirrors may be tilted at an angle about 180°/4=45° with respect to a surface (e.g., front or back surface) of the geometrical waveguide, and there may be 4 different light frustums reflected by mirrors and surfaces of the waveguide, where the k-frustum may go back to the original position with the opposite parity after being reflected by an odd number of times. The value of the odd number may depend on the location of the input frustum, and whether the odd number of reflections start with a surface reflection or a mirror reflection. FIG. 28A shows that an image with opposite parity may be coupled out of the waveguide and may overlap the displayed image. Because the overlapping images have different parity, ghost images may be displayed to the user and may degrade the image quality of the displayed image.

FIG. 28B illustrates k-vectors of light beams propagating within an example of a geometrical waveguide and reflected by surfaces and transflective mirrors of a second orientation in the geometrical waveguide. In the example shown in FIG. 28B, the transflective mirrors may be tilted at an angle about 180°/6=30° with respect to a surface (e.g., front or back surface) of the geometrical waveguide, and there may be 6 different light frustums reflected by mirrors and surfaces of the waveguide, where the k-frustum may go back to original position with the opposite parity after an odd number of reflections. The value of the odd number may depend on the location of the input frustum, and whether the odd number of reflections start with a surface reflection or a mirror reflection. FIG. 28B shows that an image with opposite parity may be coupled out of the waveguide and may overlap the displayed image. Because the overlapping images have different parity, ghost images may be displayed to the user and may degrade the image quality of the displayed image.

FIG. 28C illustrates k-vectors of light beams propagating within an example of a geometrical waveguide and reflected by surfaces and transflective mirrors having a third orientation in the geometrical waveguide. In the example shown in FIG. 28C, the transflective mirrors may be tilted at an angle about 180°/8=22.5° with respect to a surface of the geometrical waveguide, and there may be 8 different light frustums reflected by the transflective mirrors and surfaces of the waveguide, where the k-frustum may go back to the original position with the opposite parity after an odd number of reflections. The value of the odd number may depend on the location of the input frustum, and whether the odd number of reflections start with a surface reflection or a mirror reflection. FIG. 28C shows that an image with opposite parity may be coupled out of the waveguide and may overlap the displayed image. Because the overlapping images have different parity, ghost images may be displayed to the user and may degrade the image quality of the displayed image.

FIGS. 28A-28C show that, when the mirrors are tilted at an angle equal to 180°/N, where N is an even number, the k-frustum may go back to the original position with the opposite parity after an odd number of reflections, which indicates that a ghost image with the opposite parity may overlap the displayed image to degrade the quality of the displayed image.

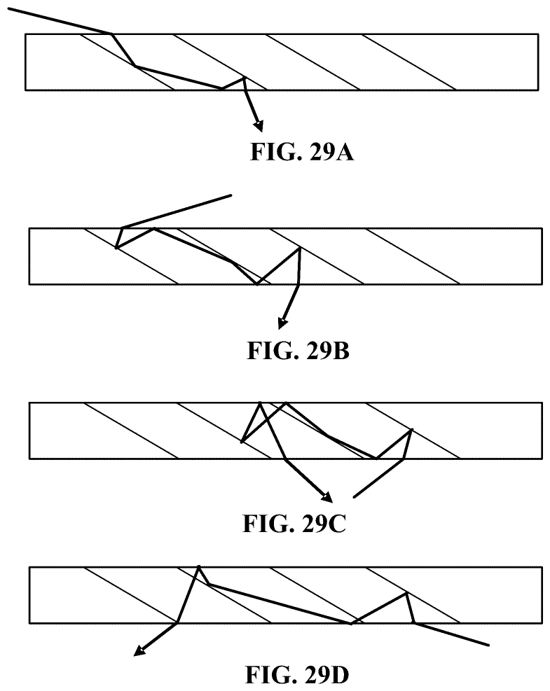

FIGS. 29A-29D show various examples of light paths of rainbow images in an example of a geometrical waveguide. The rainbow images may be caused by ambient light incident on the front surface of the geometrical waveguide at large incident angles, or may be caused by ambient light incident on the back surface of the geometrical waveguide at large incident angles. For example, FIGS. 29A and 29B show rainbow images caused by ambient light incident on the front surface of the geometrical waveguide at large incident angles from the left side and the right side, respectively. FIGS. 29C and 29D show rainbow images caused by ambient light incident on the back surface of the geometrical waveguide at large incident angles from the left side and the right side, respectively. The ambient light may be reflected multiple times by surfaces of the geometrical waveguide and transflective mirrors in the geometrical waveguide, before being refracted out of the geometrical waveguide towards the eyebox. The light paths in the illustrated examples, if unfolded, may be similar to the light path of a light ray going through a prism (or wedge). The dispersion by the prism may result in rainbow-like images of objects (e.g., light sources) in the ambient environment. The light paths of rainbow images may also be analyzed and visualized in the k-space using techniques disclosed herein.

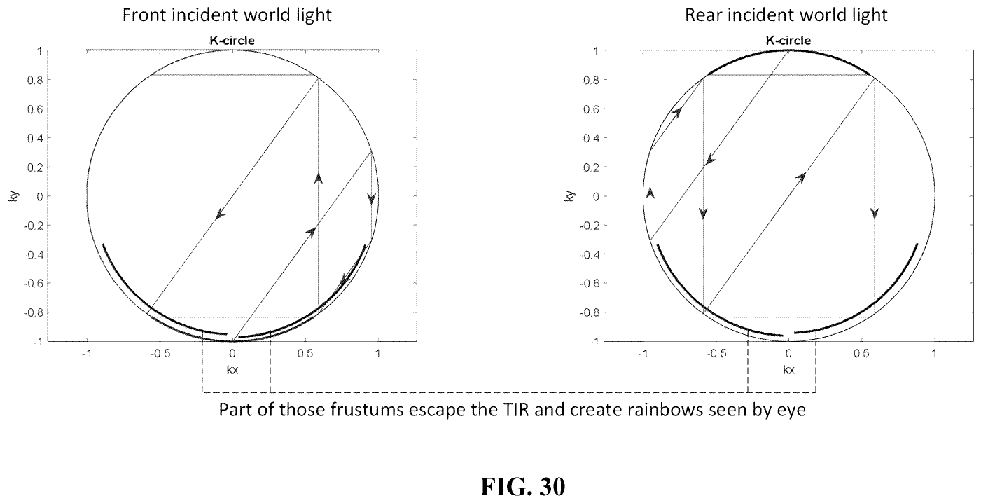

FIG. 30 illustrates examples of k-vectors of rainbow images in an example of a geometrical waveguide. In the example shown in FIG. 30, the transflective mirrors may be tilted at an angle about 36° (180°/5) with respect to the front and back surfaces of the waveguide. The waveguide may have a refractive index about 1.8. The rainbow images may be analyzed using techniques similar to the techniques for analyzing ghost images, but the frustum of ambient light may be incident on the front side or back side of the waveguide at incident angles centered around +90° or −90°. For clarity and simplicity, only selected k-frustums are shown in FIG. 30. FIG. 30 shows that there may be some portions of some frustums that may be refracted out of the waveguide and may be seen by user's eyes as rainbow images.

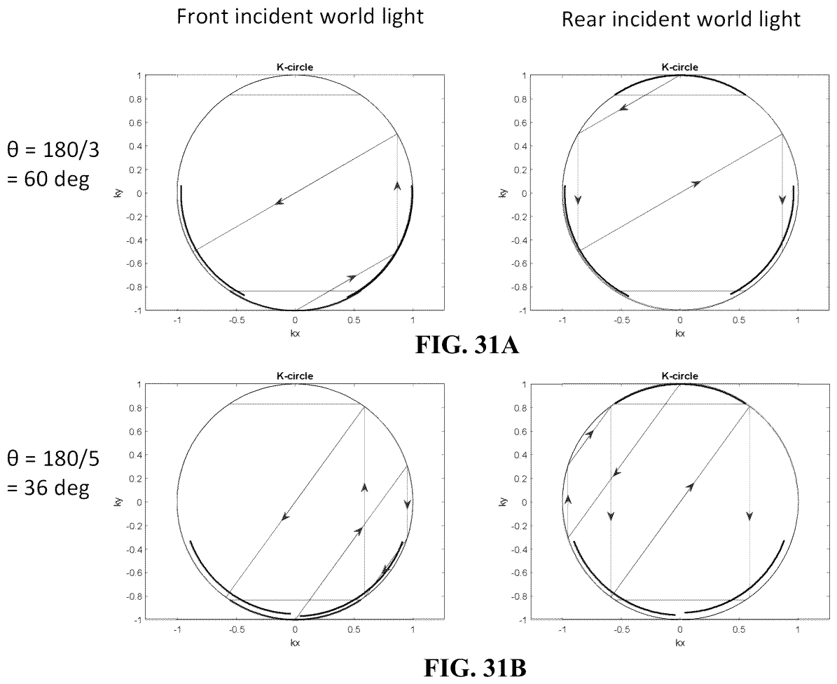

FIG. 31A illustrates examples of k-vectors of rainbow light in an example of a geometrical waveguide including transflective mirrors having a first orientation (e.g., about 180°/3=60° with respect to the front or back surface of the geometrical waveguide) in the geometrical waveguide. In the illustrated example, the frustum of ambient light may be incident on the front side or back side of the waveguide at incident angles centered around +90° or −90°. For clarity and simplicity, only selected k-frustums are shown in FIG. 31A. As shown in FIG. 31A, the two rainbow images closest to the displayed image may be located symmetrically with respect to (having equal distance from) the displayed image and may be formed by a small edge portion of the light frustum. Therefore, the rainbow images may be less likely to occur for the center field of view.

FIG. 31B illustrates examples of k-vectors of rainbow light in an example of a geometrical waveguide including transflective mirrors having a second orientation (e.g., about 180°/5=36° with respect to the front or back surface of the geometrical waveguide) in the geometrical waveguide. In the illustrated example, the frustum of ambient light may be incident on the front surface or back surface of the waveguide at incident angles centered around +90° or −90°. For clarity and simplicity, only selected k-frustums are shown in FIG. 31B. In the example shown in FIG. 31B, a larger portion of the light frustum may be refracted out of the waveguide and may be seen by user's eyes as rainbow images.

FIGS. 31A and 31B show that, when the transflective mirrors are tilted at an angle about 180°/N with respect to the front or back surface of the geometrical waveguide and N is an odd number, the two rainbow images closest to the displayed image may be located symmetrically with respect to the displayed image. When N is smaller, there may be a higher chance that the ambient light with large incident angles may be trapped inside a waveguide having a high refractive index and thus may be less likely to cause rainbow images.

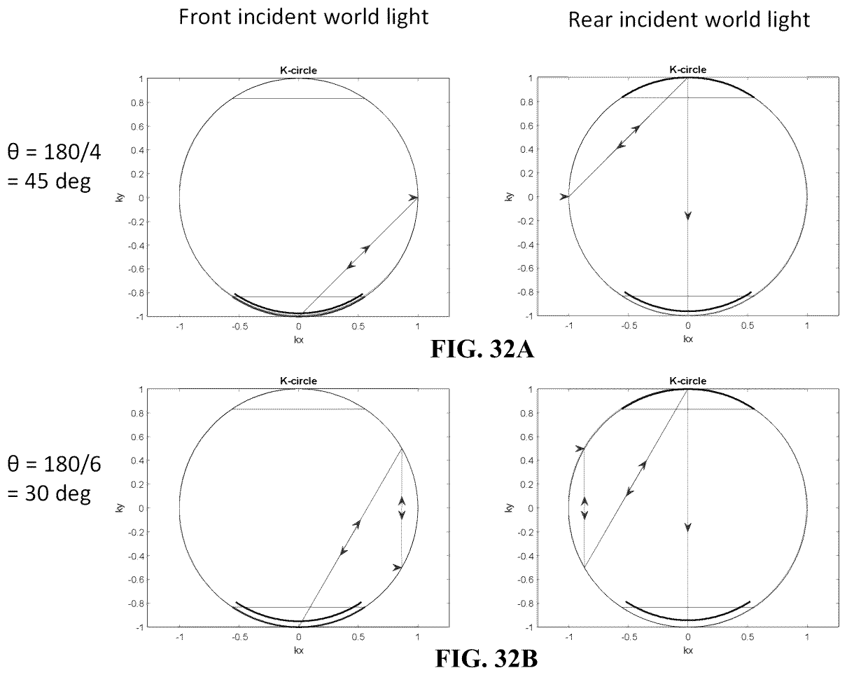

FIG. 32A illustrates examples of k-vectors of rainbow light in an example of a geometrical waveguide including transflective mirrors having a first orientation (e.g., about 180°/4=45° with respect to a front or back surface of the geometrical waveguide) in the geometrical waveguide. In the illustrated example, the input frustum of the ambient light may be incident on the front surface or back surface of the waveguide at incident angles centered around +90° or −90°. For clarity and simplicity, only selected k-frustums are shown in FIG. 32A. FIG. 32A shows that one major rainbow image may occur at the center FOV and may have an opposite parity compared with see-through ambient light.

FIG. 32B illustrates examples of k-vectors of rainbow light in an example of a geometrical waveguide including transflective mirrors having a second orientation (e.g., about 180°/6=30° with respect to a front or back surface of the geometrical waveguide) in the geometrical waveguide. In the illustrated example, the input frustum of the ambient light may be incident on the front surface or back surface of the waveguide at incident angles centered around +90° or −90°. For clarity and simplicity, only selected k-frustums are shown in FIG. 32B. FIG. 32B also shows that one major rainbow image may occur at the center FOV and may have an opposite parity compared with see-through ambient light.

FIGS. 32A and 32B show that, when the transflective mirrors are tilted at an angle about 180°/N with respect to the front or back surface of the geometrical waveguide and N is an even number, a major rainbow image may occur at the center FOV and may have an opposite parity compared with see-through ambient light.

The k-space analysis results shown in, for example, FIGS. 27A-28C and 31A-32B indicate that, to reduce or mitigate ghost and rainbow images, it may be desirable to orient the transflective mirrors at an angle about 180°/N, with N being an odd number, with respect to the front and back surfaces of a geometrical waveguide. When the mirror is oriented at an angle about 180°/N, with N being an even number, with respect to the front and back surfaces, the waveguide may have worse performance in term of its ghost and rainbow images.

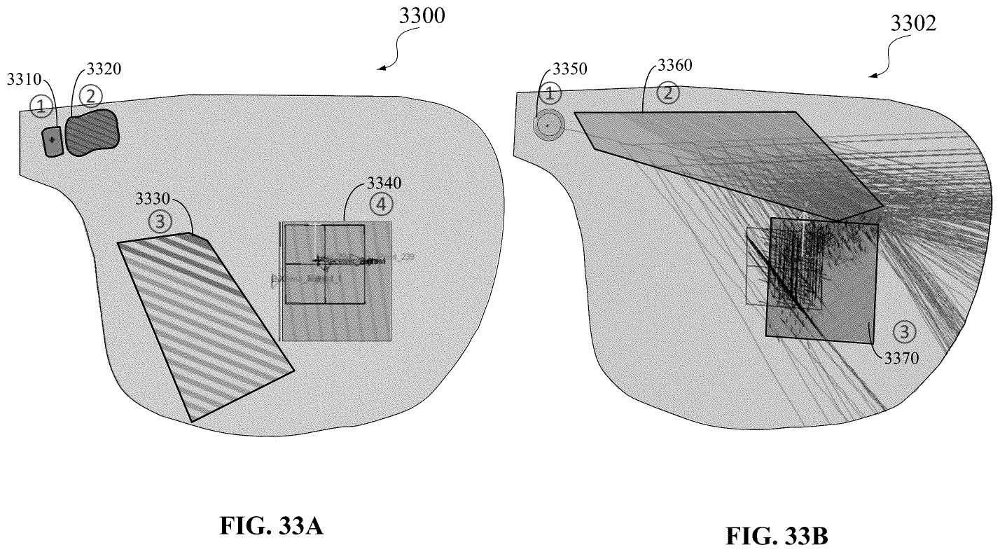

FIG. 33A illustrates an example of a geometrical waveguide display 3300 including four groups of mirrors according to certain embodiments. Geometrical waveguide display 3300 may be a two-dimensional geometrical waveguide including reflective or transflective mirrors in four areas. Input mirror(s) 3310 may be in a first area and may include a single reflective mirror or multiple transflective mirrors. Input mirror(s) 3310 may be used for coupling incident display light into the waveguide such that the display light may propagate within the waveguide towards folding mirrors 3320. Folding mirrors 3320 may redirect the display light toward folding mirrors 3330. Folding mirrors 3330 may reflect portions of the display light at multiple locations towards output mirrors 3340, which may reflect the incident display light out of the waveguide at multiple locations (e.g., a 2-D array of locations). Input mirrors 3310 and output mirrors 3340 may have the same orientation, and may compensate the dispersion caused by each other. Similarly, folding mirrors 3320 and folding mirrors 3330 may have the same orientation, and may compensate the dispersion caused by each other. Therefore, the transflective mirrors in geometrical waveguide display 3300 may only need to have two different orientations, and there may not be FOV skew or dispersion issue. However, because more groups of transflective mirrors are needed, geometrical waveguide display 3300 may be more difficult to fabricate and may have lower overall efficiency. Geometrical waveguide display 3300 may be analyzed using the 3-D k-space analysis techniques disclosed herein.

FIG. 33B illustrates an example of a geometrical waveguide display 3302 including three groups of mirrors according to certain embodiments. Mirror(s) 3350 may be used for coupling incident display light into the waveguide such that the display light may propagate within the waveguide towards folding mirror 3360, which may redirect (reflect) portions of the display light at multiple mirror locations towards output mirrors 3370. Output mirrors 3370 may reflect the incident display light out of the waveguide at multiple locations (e.g., a 2-D array of locations). Mirrors 3350, 3360, and 3370 may have different respective mirror orientations. Geometrical waveguide display 3302 may be relatively easier to fabricate than geometrical waveguide display 3300, and may have higher overall efficiency. But there may be FOV skew and chromatic aberrations caused by dispersion introduced by the mirrors. Geometrical waveguide display 3302 may also be analyzed using the k-space analysis techniques disclosed herein.

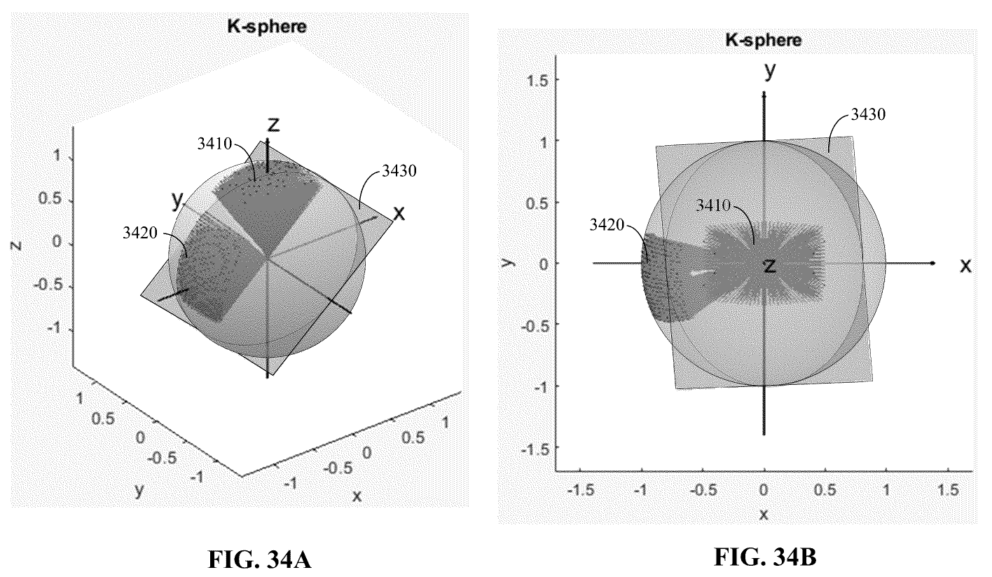

FIG. 34A illustrates k-vectors of incident light and k-vectors of light reflected by a transflective mirror (e.g., an input mirror) of a geometrical waveguide display (e.g., geometrical waveguide display 3300 or 3302) in a k-sphere. FIG. 34B illustrates k-vectors of incident light and k-vectors of light reflected by the transflective mirror of the geometrical waveguide display as projected onto a plane (e.g., an x-y plane) of the k-sphere. In FIGS. 34A and 34B, mirror 3430 may be tilted in the x-y-z space. K-vectors 3410 represent the incident light in the incident frustum, which may be centered around the surface-normal direction. K-vectors 3420 represents the frustum of the light reflected by mirror 3430. Light reflected by other mirrors with different orientations in the geometrical waveguide display may be analyzed using similar techniques.

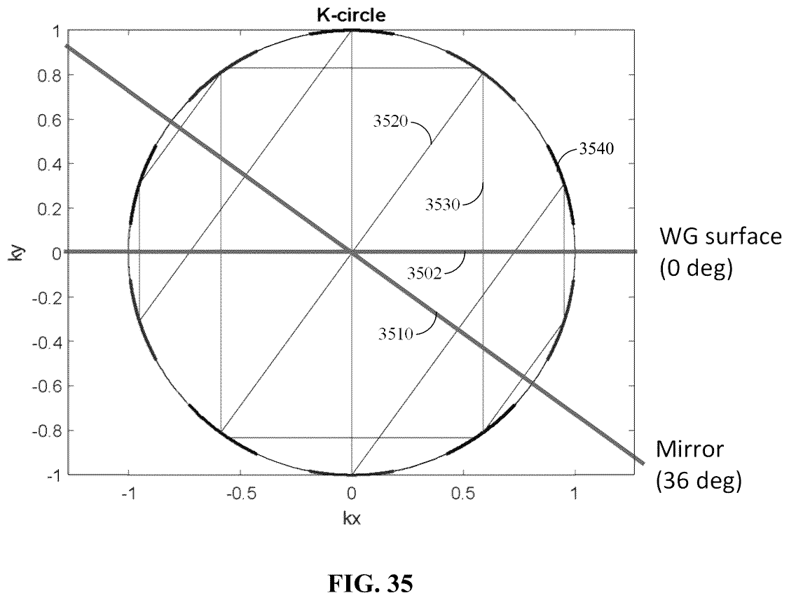

FIG. 35 illustrates examples of k-vectors of light in an example of a geometrical waveguide including mirrors having a certain orientation in the geometrical waveguide. In the illustrated example, the mirrors may be tilted at an angle about 180°/5=36° with respect to the front or back surface (represented by a line 3502) of the geometrical waveguide, as shown by a line 3510. In the k-circle shown in FIG. 35, slanted lines 3520 indicate reflection by transflective mirrors, while vertical lines 3530 indicate reflection by the front and/or back surfaces of the waveguide. The light frustum may change parity each time it is reflected. Arcs 3540 representing the light frustums may be symmetrical with respect to line 3510 that represents the mirror, and may also be symmetrical with respect to line 3502 that represents the front or back surface of the waveguide. FIG. 35 shows that there may be 10 possible different orientations (propagation directions) of a displayed image in the waveguide, where five of them may correspond to images with right-hand parity and the other five may correspond to images with left-hand parity.

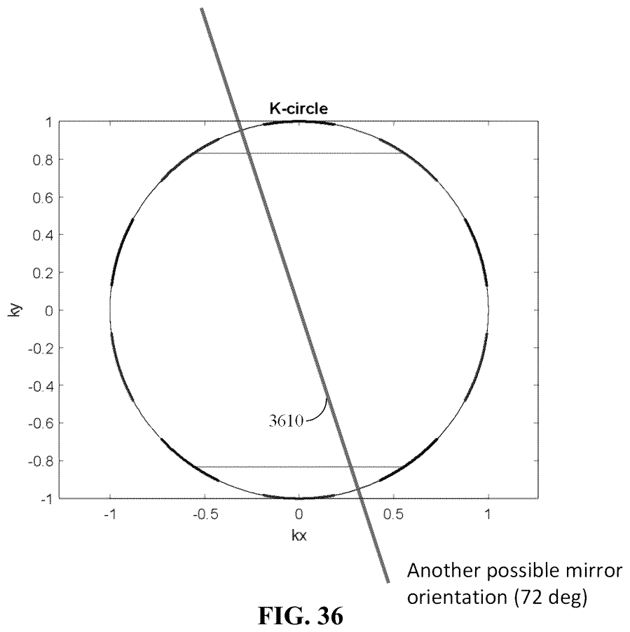

FIG. 36 illustrates examples of k-vectors of light in an example of a geometrical waveguide including a mirror having a certain orientation in the geometrical waveguide. FIG. 36 shows that, when a mirror of the geometrical waveguide is tilted at an angle about 72° with respect to the front or back surface of the geometrical waveguide, as indicated by a line 3610, there may be 10 possible different orientations (propagation directions) of a displayed image in the waveguide, where the 10 possible different orientations of the displayed image in the geometrical waveguide overlap and have the same parity as the 10 possible different orientations of the displayed image in the geometrical waveguide of FIG. 35. Therefore, adding mirrors oriented at 72° to a geometrical waveguide having mirrors oriented at 36° may not cause any additional light frustums or ghost images.

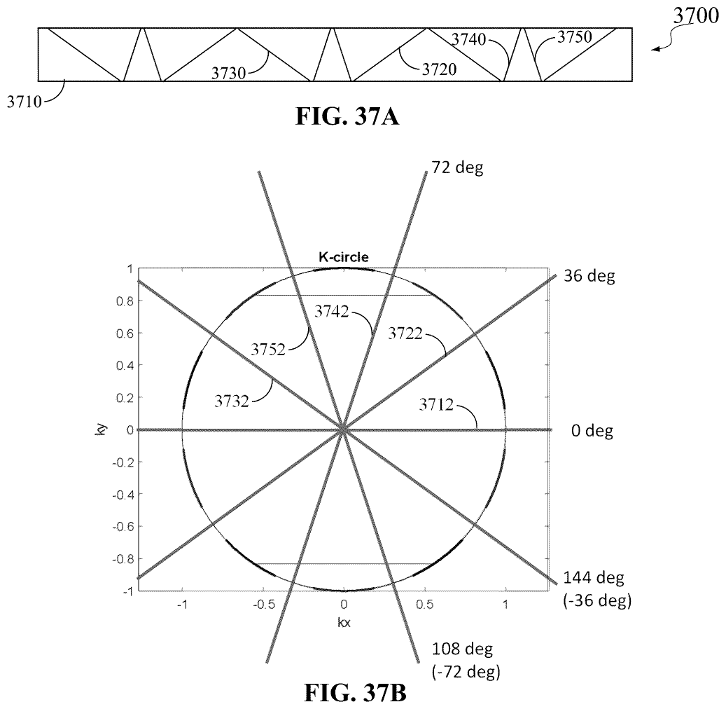

FIG. 37A illustrates an example of a geometrical waveguide 3700 including mirrors having different orientations inside geometrical waveguide 3700. In the example shown in FIG. 37, the mirrors may be oriented at about +36° (e.g., mirrors 3720 and 3730) and about +72° (e.g., mirrors 3740 and 3750) with respect to the front or back surface 3710 of the geometrical waveguide.

FIG. 37B illustrates examples of k-vectors of light in the example of geometrical waveguide 3700 including mirrors having different orientations. In the example shown in FIG. 37B, the mirrors may be indicated by a line 3712 (at about 0°, e.g., at a surface of the waveguide), lines 3722 and 3732 (tilted at about +36°), and lines 3742 and 3752 (tilted at about)+72°. FIG. 37B shows that the k-frustums associated with the mirrors having different orientations map overlap, and the overlapped k-frustums associated with mirrors having different orientations may have matching disparity. Therefore, no additional k-frustums or ghost images may be introduced by including mirrors having different orientations in the same geometrical waveguide.

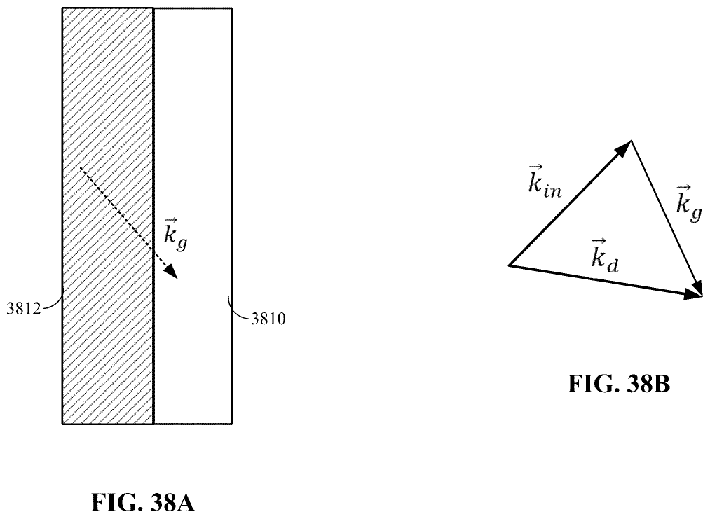

As described above, techniques disclosed herein may also be used to perform 3-D analysis of devices with volume Bragg gratings or other volume gratings. FIG. 38A illustrates an example of a volume Bragg grating 3812 formed on a substrate 3810, where the grating vector of volume Bragg grating 3812 is \vec{k}_{g}. FIG. 38B illustrates the relationship between the wave vector \vec{k}_{d} of a light beam diffracted by a VBG, and the grating vector \vec{k}_{g} of the VBG and the wave vector \vec{k}ᵢₙ of the input beam. As illustrated, the wave vector \vec{k}_{d} of the light beam diffracted by a VBG can be determined using a k-space triangle based on the grating vector \vec{k}_{g} of the VBG and the wave vector \vec{k}ᵢₙ of the input beam according to \vec{k}_{d}=\vec{k}ᵢₙ+\vec{k}_{g}.

Embodiments of the invention may include or be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

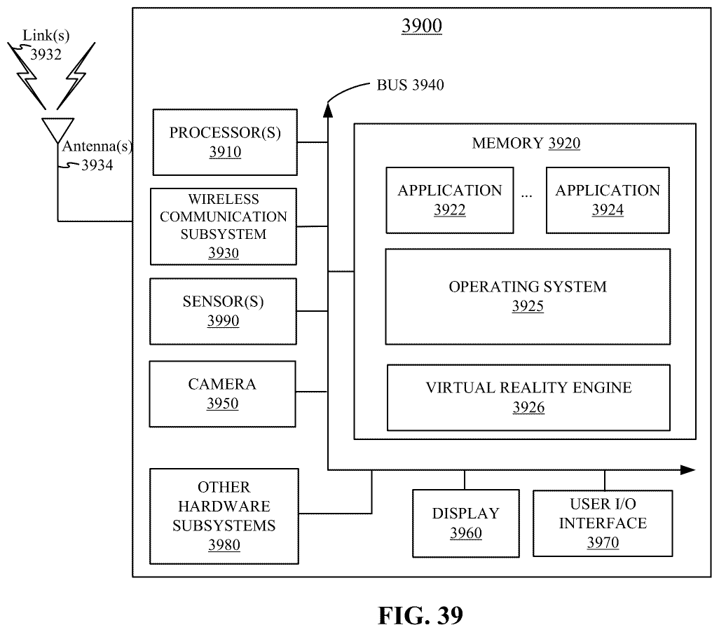

FIG. 39 is a simplified block diagram of an example electronic system 3900 of an example near-eye display (e.g., HMD device) for implementing some of the examples disclosed herein. Electronic system 3900 may be used as the electronic system of an HMD device or other near-eye displays described above. In this example, electronic system 3900 may include one or more processor(s) 3910 and a memory 3920. Processor(s) 3910 may be configured to execute instructions for performing operations at a number of components, and can be, for example, a general-purpose processor or microprocessor suitable for implementation within a portable electronic device. Processor(s) 3910 may be communicatively coupled with a plurality of components within electronic system 3900. To realize this communicative coupling, processor(s) 3910 may communicate with the other illustrated components across a bus 3940. Bus 3940 may be any subsystem adapted to transfer data within electronic system 3900. Bus 3940 may include a plurality of computer buses and additional circuitry to transfer data.

Memory 3920 may be coupled to processor(s) 3910. In some embodiments, memory 3920 may offer both short-term and long-term storage and may be divided into several units. Memory 3920 may be volatile, such as static random access memory (SRAM) and/or dynamic random access memory (DRAM) and/or non-volatile, such as read-only memory (ROM), flash memory, and the like. Furthermore, memory 3920 may include removable storage devices, such as secure digital (SD) cards. Memory 3920 may provide storage of computer-readable instructions, data structures, program code, and other data for electronic system 3900. In some embodiments, memory 3920 may be distributed into different hardware subsystems. A set of instructions and/or code might be stored on memory 3920. The instructions might take the form of executable code that may be executable by electronic system 3900, and/or might take the form of source and/or installable code, which, upon compilation and/or installation on electronic system 3900 (e.g., using any of a variety of generally available compilers, installation programs, compression/decompression utilities, etc.), may take the form of executable code.

In some embodiments, memory 3920 may store a plurality of applications 3922 through 3924, which may include any number of applications. Examples of applications may include gaming applications, conferencing applications, video playback applications, or other suitable applications. The applications may include a depth sensing function or eye tracking function. Applications 3922-3924 may include particular instructions to be executed by processor(s) 3910. In some embodiments, certain applications or parts of applications 3922-3924 may be executable by other hardware subsystems 3980. In certain embodiments, memory 3920 may additionally include secure memory, which may include additional security controls to prevent copying or other unauthorized access to secure information.

In some embodiments, memory 3920 may include an operating system 3925 loaded therein. Operating system 3925 may be operable to initiate the execution of the instructions provided by applications 3922-3924 and/or manage other hardware subsystems 3980 as well as interfaces with a wireless communication subsystem 3930 which may include one or more wireless transceivers. Operating system 3925 may be adapted to perform other operations across the components of electronic system 3900 including threading, resource management, data storage control and other similar functionality.

Wireless communication subsystem 3930 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 3900 may include one or more antennas 3934 for wireless communication as part of wireless communication subsystem 3930 or as a separate component coupled to any portion of the system. Depending on desired functionality, wireless communication subsystem 3930 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 3930 may permit data to be exchanged with a network, other computer systems, and/or any other devices described herein. Wireless communication subsystem 3930 may include a means for transmitting or receiving data, such as identifiers of HMD devices, position data, a geographic map, a heat map, photos, or videos, using antenna(s) 3934 and wireless link(s) 3932.

Embodiments of electronic system 3900 may also include one or more sensors 3990. Sensor(s) 3990 may include, for example, an image sensor, an accelerometer, a pressure sensor, a temperature sensor, a proximity sensor, a magnetometer, a gyroscope, an inertial sensor (e.g., a subsystem that combines an accelerometer and a gyroscope), an ambient light sensor, or any other similar devices or subsystems operable to provide sensory output and/or receive sensory input, such as a depth sensor or a position sensor. For example, in some implementations, sensor(s) 3990 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 3900 may include a display 3960. Display 3960 may be a near-eye display, and may graphically present information, such as images, videos, and various instructions, from electronic system 3900 to a user. Such information may be derived from one or more applications 3922-3924, virtual reality engine 3926, one or more other hardware subsystems 3980, a combination thereof, or any other suitable means for resolving graphical content for the user (e.g., by operating system 3925). Display 3960 may use liquid crystal display (LCD) technology, light-emitting diode (LED) technology (including, for example, OLED, ILED, uLED, AMOLED, TOLED, etc.), light emitting polymer display (LPD) technology, or some other display technology.

Electronic system 3900 may include a user input/output interface 3970. User input/output interface 3970 may allow a user to send action requests to electronic system 3900. An action request may be a request to perform a particular action. For example, an action request may be to start or end an application or to perform a particular action within the application. User input/output interface 3970 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 3900. In some embodiments, user input/output interface 3970 may provide haptic feedback to the user in accordance with instructions received from electronic system 3900. For example, the haptic feedback may be provided when an action request is received or has been performed.

Electronic system 3900 may include a camera 3950 that may be used to take photos or videos of a user, for example, for tracking the user's eye position. Camera 3950 may also be used to take photos or videos of the environment, for example, for VR, AR, or MR applications. Camera 3950 may include, for example, a complementary metal-oxide-semiconductor (CMOS) image sensor with a few millions or tens of millions of pixels. In some implementations, camera 3950 may include two or more cameras that may be used to capture 3-D images.

In some embodiments, electronic system 3900 may include a plurality of other hardware subsystems 3980. Each of other hardware subsystems 3980 may be a physical subsystem within electronic system 3900. While each of other hardware subsystems 3980 may be permanently configured as a structure, some of other hardware subsystems 3980 may be temporarily configured to perform specific functions or temporarily activated. Examples of other hardware subsystems 3980 may include, for example, an audio output and/or input interface (e.g., a microphone or speaker), a near field communication (NFC) device, a rechargeable battery, a battery management system, a wired/wireless battery charging system, etc. In some embodiments, one or more functions of other hardware subsystems 3980 may be implemented in software.

In some embodiments, memory 3920 of electronic system 3900 may also store a virtual reality engine 3926. Virtual reality engine 3926 may execute applications within electronic system 3900 and receive position information, acceleration information, velocity information, predicted future positions, or some combination thereof of the HMD device from the various sensors. In some embodiments, the information received by virtual reality engine 3926 may be used for producing a signal (e.g., display instructions) to display 3960. For example, if the received information indicates that the user has looked to the left, virtual reality engine 3926 may generate content for the HMD device that mirrors the user's movement in a virtual environment. Additionally, virtual reality engine 3926 may perform an action within an application in response to an action request received from user input/output interface 3970 and provide feedback to the user. The provided feedback may be visual, audible, or haptic feedback. In some implementations, processor(s) 3910 may include one or more GPUs that may execute virtual reality engine 3926.

In various implementations, the above-described hardware and subsystems may be implemented on a single device or on multiple devices that can communicate with one another using wired or wireless connections. For example, in some implementations, some components or subsystems, such as GPUs, virtual reality engine 3926, and applications (e.g., tracking application), may be implemented on a console separate from the head-mounted display device. In some implementations, one console may be connected to or support more than one HMD.

In alternative configurations, different and/or additional components may be included in electronic system 3900. Similarly, functionality of one or more of the components can be distributed among the components in a manner different from the manner described above. For example, in some embodiments, electronic system 3900 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components, or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A geometrical waveguide display comprising:
a substrate; and
a first plurality of transflective mirrors in the substrate, the first plurality of transflective mirrors characterized by a tilt angle of n×180°/N with respect to a surface of the substrate, wherein N is an odd number and n is an integer smaller than N.

2. The geometrical waveguide display of claim 1, further comprising a second plurality of transflective mirrors in the substrate, the second plurality of transflective mirrors characterized by a tilt angle of m×180°/N with respect to the surface of the substrate, wherein m is an integer smaller than N and is different from n.

3. The geometrical waveguide display of claim 1, further comprising a second plurality of transflective mirrors in the substrate, the second plurality of transflective mirrors characterized by a tilt angle of −n×180°/N with respect to the surface of the substrate.

4. The geometrical waveguide display of claim 1, wherein a refractive index of the substrate is greater than 1.7.

5. The geometrical waveguide display of claim 1, wherein:
the substrate extends in a first direction; and
a first input coupler configured to couple display light into the substrate such that the display light is reflected through total internal reflection by three or more surfaces of the 4 substrate that are parallel to the first direction to propagate within the substrate in the first direction.

6. The geometrical waveguide display of claim 5, wherein the first plurality of transflective mirrors is configured to reflect portions of the display light out of the substrate through a surface of the substrate.

7. The geometrical waveguide display of claim 1, wherein the substrate has a bar shape and has a cross-section characterized by a shape of a polygon.

8. The geometrical waveguide display of claim 1, further comprising a second plurality of transflective mirrors in the substrate, wherein:
the first plurality of transflective mirrors and the second plurality of transflective mirrors are in different regions of the substrate; and
the first plurality of transflective mirrors are configured to reflect light towards the second plurality of transflective mirrors.

9. A method of analyzing a waveguide display, the method comprising:
determining a wave vector frustum of an input light frustum in a three-dimensional (3-D) wave vector space (k-space), the wave vector frustum including a plurality of wave vectors \vec{k}ᵢₙ;
determining a surface-normal vector î of a first reflector of the waveguide display; and
determining a wave vector frustum of a light frustum reflected by the first reflector, the wave vector frustum of the light frustum reflected by the first reflector including a plurality of wave vectors \vec{k}ᵣ determined according to:
$${\vec{k}}_{r} = {\vec{k}}_{i n} - 2 ( {\vec{k}}_{i n} \cdot \hat{n} ) \hat{n} .$$

10. The method of claim 9, wherein the first reflector includes a surface of a waveguide of the waveguide display or a transflective mirror in the waveguide display.

11. The method of claim 9, further comprising displaying the wave vector frustum of the input light frustum and the wave vector frustum of the light frustum reflected by the first reflector in a k-sphere.

12. The method of claim 11, further comprising determining a field of view supported by the waveguide display based on the wave vector frustum of the light frustum reflected by the first reflector in the k-sphere and regions of the k-sphere representing wave vectors of light that can be guided by the waveguide display.

13. The method of claim 11, further comprising determining a ghost image path of the waveguide display based on the wave vector frustum of the light frustum reflected by the first reflector in the k-sphere and regions of the k-sphere representing wave vectors of light that can escape from the waveguide display.

14. A waveguide display comprising:
a first pupil expander extending in a first direction, the first pupil expander configured to:
reflect display light through total internal reflection at three or more surfaces that are parallel to the first direction to guide the display light along the first direction; and
couple the display light out of the first pupil expander at a first plurality of locations along the first direction; and
a second pupil expander configured to split the display light from each location of the first plurality of locations of the first pupil expander at a second plurality of locations along a second direction that is different from the first direction,
wherein the display light from each location of the first plurality of locations of the first pupil expander is coupled into the second pupil expander through an edge of the second pupil expander.

15. The waveguide display of claim 14, where the first pupil expander is configured to couple the display light out of the first pupil expander through a surface adjacent to the edge of the second pupil expander.

16. The waveguide display of claim 14, where the edge of the second pupil expander is slanted with respect to a surface of the second pupil expander.

17. The waveguide display of claim 14, wherein the first pupil expander includes a first plurality of transflective mirrors.

18. The waveguide display of claim 17, wherein the first plurality of transflective mirrors is characterized by a tilt angle of n×180°/N with respect to a surface of the first pupil expander, wherein N is an odd number and n is an integer smaller than N.

19. The waveguide display of claim 18, further comprising a second plurality of transflective mirrors in the first pupil expander, the second plurality of transflective mirrors characterized by a tilt angle of m×180°/N with respect to the surface of the first pupil expander, wherein m is an integer smaller than N and is different from n.

20. The waveguide display of claim 18, further comprising a second plurality of transflective mirrors in the first pupil expander, the second plurality of transflective mirrors characterized by a tilt angle of −n×180°/N with respect to the surface of the waveguide display.
